(19) United States
(12) Patent Application Publication
(10) Pub. No.: US 2025/0377763 A1
(43) Pub. Date: Dec. 11, 2025

(54) TECHNIQUES FOR MANAGING OPERATIONS OF A CONTROLLED DEVICE

(71) Applicant: Apple Inc., Cupertino, CA (US)

(72) Inventor: Mischa K. MCLACHLAN, San Francisco, CA (US)

(21) Appl. No.: 19/223,570

(22) Filed: May 30, 2025

Related U.S. Application Data
(60) Provisional application No. 63/657,896, filed on Jun. 9, 2024.

(51) Int. Cl. G06F 3/0482; G06F 3/0484

(52) U.S. Cl. CPC G06F 3/0482; G06F 3/0484

(57) ABSTRACT

The present disclosure generally relates to managing operations of a controlled device. Some techniques are for updating a room list for while a device performs one or more operations in accordance with some embodiments. Other techniques are for displaying user interfaces to control a device in accordance with some embodiments.

### CROSS-REFERENCE TO RELATED APPLICATIONS

The present application claims priority to U.S. Provisional Patent Application Ser. No. 63/657,896, entitled “TECHNIQUES FOR MANAGING OPERATIONS OF A CONTROLLED DEVICE” filed Jun. 9, 2024, which is hereby incorporated by reference in its entirety for all purposes.

### FIELD

The present disclosure relates generally to computer user interfaces, and more specifically to techniques for managing operations of a controlled device.

### BACKGROUND

Electronic devices often provide an ability to control one or more operations of another device. Such control can be based on interactions between a user and the electronic device.

### SUMMARY

Some techniques for managing operations of a controlled device using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient processes and interfaces for managing operations of a controlled device. Such processes and interfaces optionally complement or replace other processes for managing operations of a controlled device. Such processes and interfaces reduce the cognitive burden on a user and produce a more efficient human-machine interface. For battery-operated computing devices, such processes and interfaces conserve power and increase the time between battery charges. Such processes can provide an ability to manage a controlled device even while the controlled device is performing an operation, thereby allowing the controlled device to adapt to the user's inputs rather than entirely completing or abandoning initially programmed operations.

In some embodiments, a method that is performed at a computer system that is in communication with one or more display generation components and one or more input devices is described. In some embodiments, the method comprises: while displaying, via the one or more display generation components, a room list including an indication that a device is currently performing a respective operation in a first room, detecting, via the one or more input devices, an input corresponding to a request to modify the room list; and in response to detecting the input corresponding to the request to modify the room list: in accordance with a determination that a first set of one or more criteria is satisfied, updating the room list in a first manner; and in accordance with a determination that a second set of one or more criteria, different from the first set of one or more criteria, is satisfied, updating the room list in a second manner different from the first manner.

In some embodiments, a non-transitory computer-readable storage medium storing one or more programs configured to be executed by one or more processors of a computer system that is in communication with one or more display generation components and one or more input devices is described. In some embodiments, the one or more programs includes instructions for: while displaying, via the one or more display generation components, a room list including an indication that a device is currently performing a respective operation in a first room, detecting, via the one or more input devices, an input corresponding to a request to modify the room list; and in response to detecting the input corresponding to the request to modify the room list: in accordance with a determination that a first set of one or more criteria is satisfied, updating the room list in a first manner; and in accordance with a determination that a second set of one or more criteria, different from the first set of one or more criteria, is satisfied, updating the room list in a second manner different from the first manner.

In some embodiments, a transitory computer-readable storage medium storing one or more programs configured to be executed by one or more processors of a computer system that is in communication with one or more display generation components and one or more input devices is described. In some embodiments, the one or more programs includes instructions for: while displaying, via the one or more display generation components, a room list including an indication that a device is currently performing a respective operation in a first room, detecting, via the one or more input devices, an input corresponding to a request to modify the room list; and in response to detecting the input corresponding to the request to modify the room list: in accordance with a determination that a first set of one or more criteria is satisfied, updating the room list in a first manner; and in accordance with a determination that a second set of one or more criteria, different from the first set of one or more criteria, is satisfied, updating the room list in a second manner different from the first manner.

In some embodiments, a computer system configured to communicate with one or more display generation components and one or more input devices is described. In some embodiments, the computer system comprises one or more processors and memory storing one or more programs configured to be executed by the one or more processors. In some embodiments, the one or more programs includes instructions for: while displaying, via the one or more display generation components, a room list including an indication that a device is currently performing a respective operation in a first room, detecting, via the one or more input devices, an input corresponding to a request to modify the room list; and in response to detecting the input corresponding to the request to modify the room list: in accordance with a determination that a first set of one or more criteria is satisfied, updating the room list in a first manner; and in accordance with a determination that a second set of one or more criteria, different from the first set of one or more criteria, is satisfied, updating the room list in a second manner different from the first manner.

In some embodiments, a computer system configured to communicate with one or more display generation components and one or more input devices is described. In some embodiments, the computer system comprises means for performing each of the following steps: while displaying, via the one or more display generation components, a room list including an indication that a device is currently performing a respective operation in a first room, detecting, via the one or more input devices, an input corresponding to a request to modify the room list; and in response to detecting the input corresponding to the request to modify the room list: in accordance with a determination that a first set of one or more criteria is satisfied, updating the room list in a first manner; and in accordance with a determination that a second set of one or more criteria, different from the first set of one or more criteria, is satisfied, updating the room list in a second manner different from the first manner.

In some embodiments, a computer program product is described. In some embodiments, the computer program product comprises one or more programs configured to be executed by one or more processors of a computer system that is in communication with one or more display generation components and one or more input devices. In some embodiments, the one or more programs include instructions for: while displaying, via the one or more display generation components, a room list including an indication that a device is currently performing a respective operation in a first room, detecting, via the one or more input devices, an input corresponding to a request to modify the room list; and in response to detecting the input corresponding to the request to modify the room list: in accordance with a determination that a first set of one or more criteria is satisfied, updating the room list in a first manner; and in accordance with a determination that a second set of one or more criteria, different from the first set of one or more criteria, is satisfied, updating the room list in a second manner different from the first manner.

In some embodiments, a method that is performed at a computer system that is in communication with one or more display generation components and one or more input devices is described. In some embodiments, the method comprises: while displaying, via the one or more display generation components, a first user interface including a first selectable user interface element for selecting a set of one or more rooms and a second selectable user interface element, different from the first selectable user interface element, for changing a state of a device with respect to performing a first type of operation in the one or more rooms, detecting, via the one or more input devices, an input; and in response to detecting the input: in accordance with a determination that the input is a first type of input, displaying, via the one or more display generation components, a second user interface different from the first user interface, wherein the second user interface includes a third selectable user interface element for changing the first type of operation to another type of operation different from the first type of operation; and in accordance with a determination that the input is a second type of input different from the first type of input, forgoing display of, via the one or more display generation components, the second user interface.

In some embodiments, a non-transitory computer-readable storage medium storing one or more programs configured to be executed by one or more processors of a computer system that is in communication with one or more display generation components and one or more input devices is described. In some embodiments, the one or more programs includes instructions for: while displaying, via the one or more display generation components, a first user interface including a first selectable user interface element for selecting a set of one or more rooms and a second selectable user interface element, different from the first selectable user interface element, for changing a state of a device with respect to performing a first type of operation in the one or more rooms, detecting, via the one or more input devices, an input; and in response to detecting the input: in accordance with a determination that the input is a first type of input, displaying, via the one or more display generation components, a second user interface different from the first user interface, wherein the second user interface includes a third selectable user interface element for changing the first type of operation to another type of operation different from the first type of operation; and in accordance with a determination that the input is a second type of input different from the first type of input, forgoing display of, via the one or more display generation components, the second user interface.

In some embodiments, a transitory computer-readable storage medium storing one or more programs configured to be executed by one or more processors of a computer system that is in communication with one or more display generation components and one or more input devices is described. In some embodiments, the one or more programs includes instructions for: while displaying, via the one or more display generation components, a first user interface including a first selectable user interface element for selecting a set of one or more rooms and a second selectable user interface element, different from the first selectable user interface element, for changing a state of a device with respect to performing a first type of operation in the one or more rooms, detecting, via the one or more input devices, an input; and in response to detecting the input: in accordance with a determination that the input is a first type of input, displaying, via the one or more display generation components, a second user interface different from the first user interface, wherein the second user interface includes a third selectable user interface element for changing the first type of operation to another type of operation different from the first type of operation; and in accordance with a determination that the input is a second type of input different from the first type of input, forgoing display of, via the one or more display generation components, the second user interface.

In some embodiments, a computer system configured to communicate with one or more display generation components and one or more input devices is described. In some embodiments, the computer system comprises one or more processors and memory storing one or more programs configured to be executed by the one or more processors. In some embodiments, the one or more programs includes instructions for: while displaying, via the one or more display generation components, a first user interface including a first selectable user interface element for selecting a set of one or more rooms and a second selectable user interface element, different from the first selectable user interface element, for changing a state of a device with respect to performing a first type of operation in the one or more rooms, detecting, via the one or more input devices, an input; and in response to detecting the input: in accordance with a determination that the input is a first type of input, displaying, via the one or more display generation components, a second user interface different from the first user interface, wherein the second user interface includes a third selectable user interface element for changing the first type of operation to another type of operation different from the first type of operation; and in accordance with a determination that the input is a second type of input different from the first type of input, forgoing display of, via the one or more display generation components, the second user interface.

In some embodiments, a computer system configured to communicate with one or more display generation components and one or more input devices is described. In some embodiments, the computer system comprises means for performing each of the following steps: while displaying, via the one or more display generation components, a first user interface including a first selectable user interface element for selecting a set of one or more rooms and a second selectable user interface element, different from the first selectable user interface element, for changing a state of a device with respect to performing a first type of operation in the one or more rooms, detecting, via the one or more input devices, an input; and in response to detecting the input: in accordance with a determination that the input is a first type of input, displaying, via the one or more display generation components, a second user interface different from the first user interface, wherein the second user interface includes a third selectable user interface element for changing the first type of operation to another type of operation different from the first type of operation; and in accordance with a determination that the input is a second type of input different from the first type of input, forgoing display of, via the one or more display generation components, the second user interface.

In some embodiments, a computer program product is described. In some embodiments, the computer program product comprises one or more programs configured to be executed by one or more processors of a computer system that is in communication with one or more display generation components and one or more input devices. In some embodiments, the one or more programs include instructions for: while displaying, via the one or more display generation components, a first user interface including a first selectable user interface element for selecting a set of one or more rooms and a second selectable user interface element, different from the first selectable user interface element, for changing a state of a device with respect to performing a first type of operation in the one or more rooms, detecting, via the one or more input devices, an input; and in response to detecting the input: in accordance with a determination that the input is a first type of input, displaying, via the one or more display generation components, a second user interface different from the first user interface, wherein the second user interface includes a third selectable user interface element for changing the first type of operation to another type of operation different from the first type of operation; and in accordance with a determination that the input is a second type of input different from the first type of input, forgoing display of, via the one or more display generation components, the second user interface.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient processes and interfaces for managing operations of a controlled device, thereby increasing the effectiveness, efficiency, and user satisfaction with such devices. Such processes and interfaces may complement or replace other processes for managing operations of a controlled device.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIG. 5I illustrates an electronic device in accordance with some embodiments.

FIG. 5J is a block diagram illustrating an electronic device in accordance with some embodiments.

FIGS. 6A-6W illustrate exemplary user interfaces for managing operations performed by a controlled device using a smart phone in accordance with some embodiments.

FIG. 7 is a flow diagram illustrating a process for updating a room list for while a device performs one or more operations in accordance with some embodiments.

FIGS. 8A-8J illustrate exemplary user interfaces for managing operations performed by a controlled device using a smart watch in accordance with some embodiments.

FIG. 9 is a flow diagram illustrating a process for displaying user interfaces to control a device in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

There is a need for electronic devices that provide efficient processes and interfaces for managing operations of a controlled device. For example, operations of a controlled device can be managed via a user interface while the controlled device is currently performing one or more operations. By further example, separate user interfaces can be provided to control different aspects of the operations to be performed by the controlled device. Such techniques can reduce the cognitive burden on a user who manages operations of the controlled device, thereby enhancing productivity. Further, such techniques can reduce processor and battery power otherwise wasted on redundant user inputs.

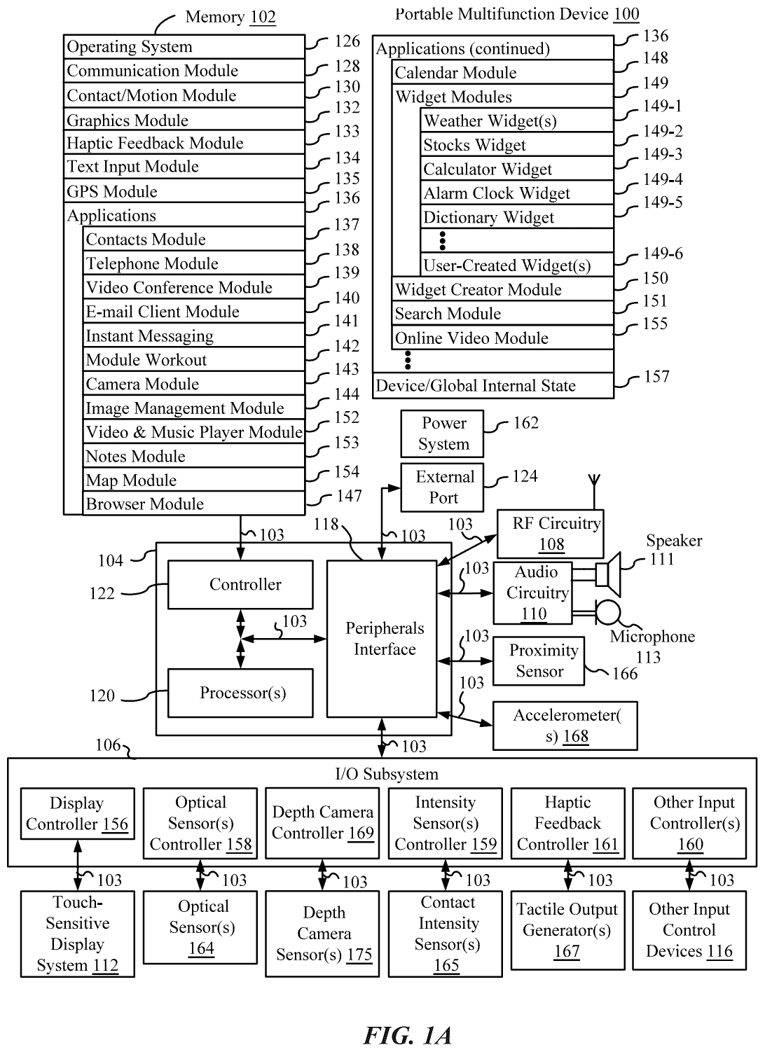

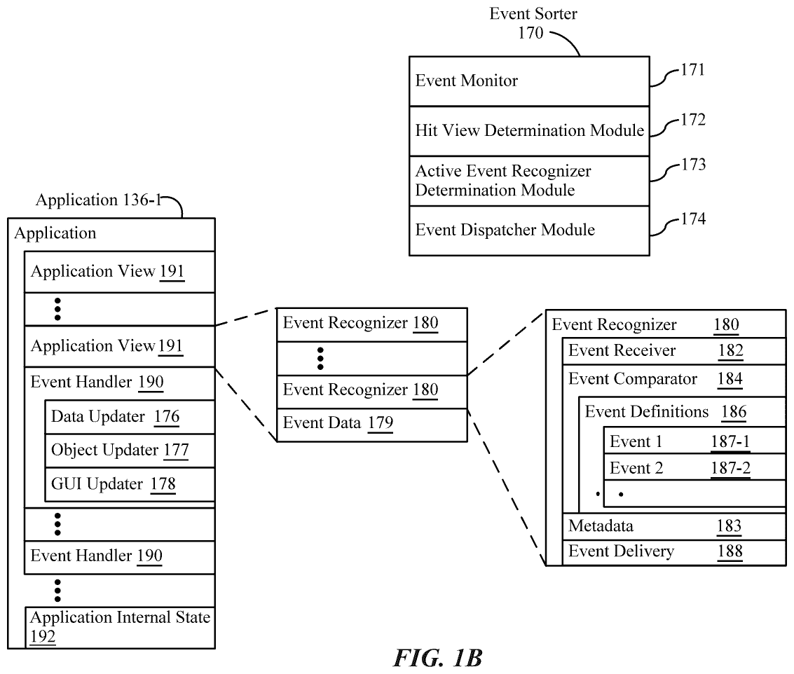

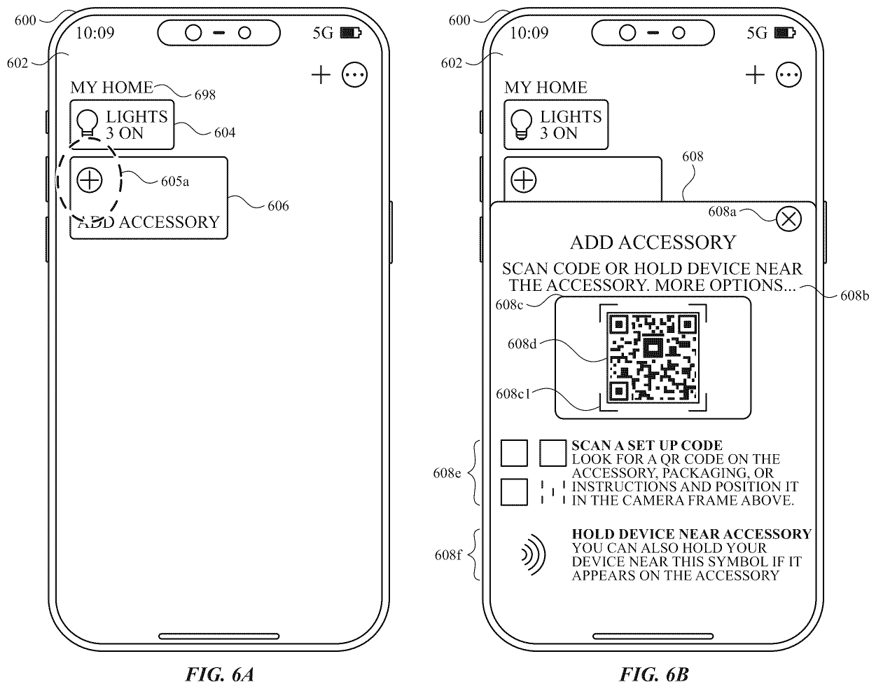

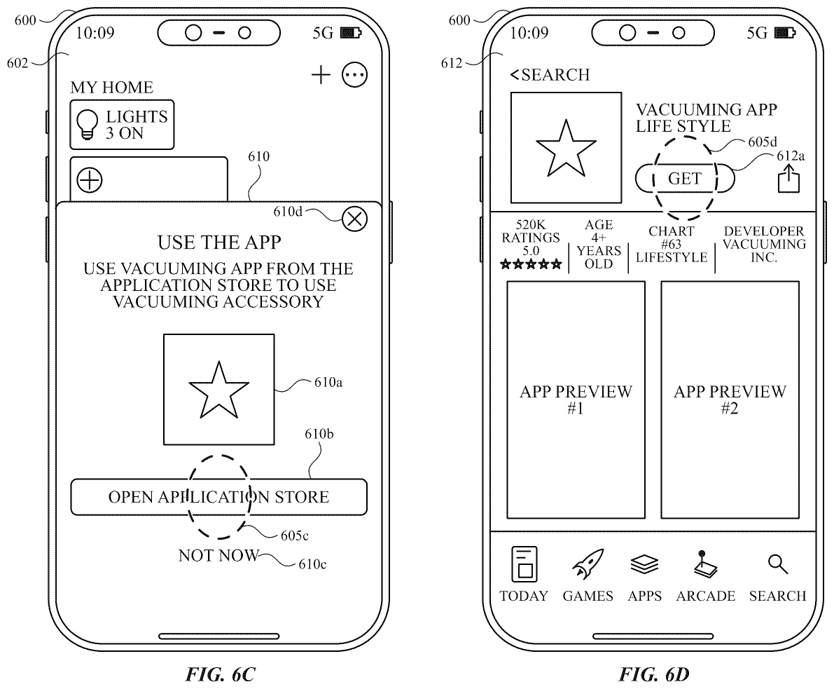

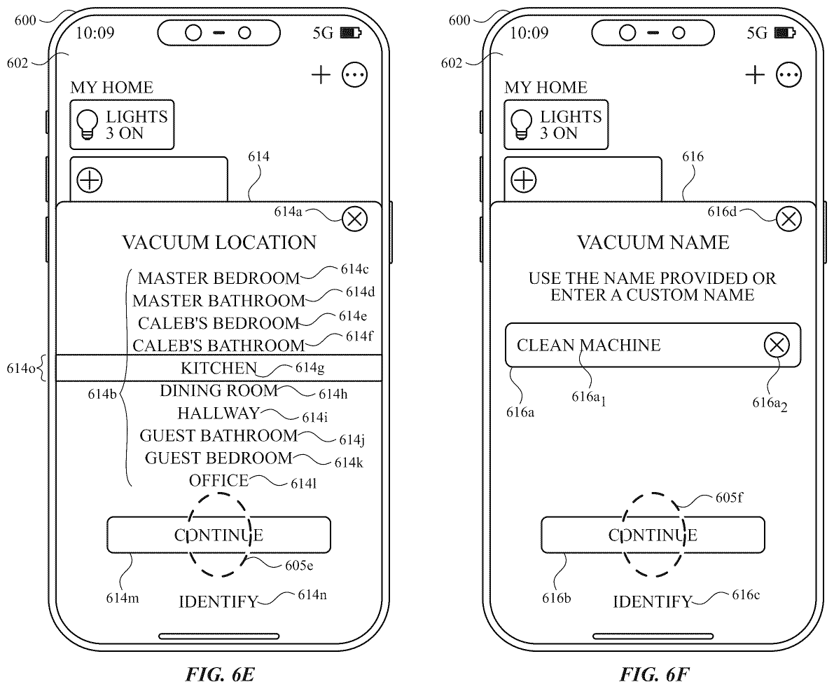

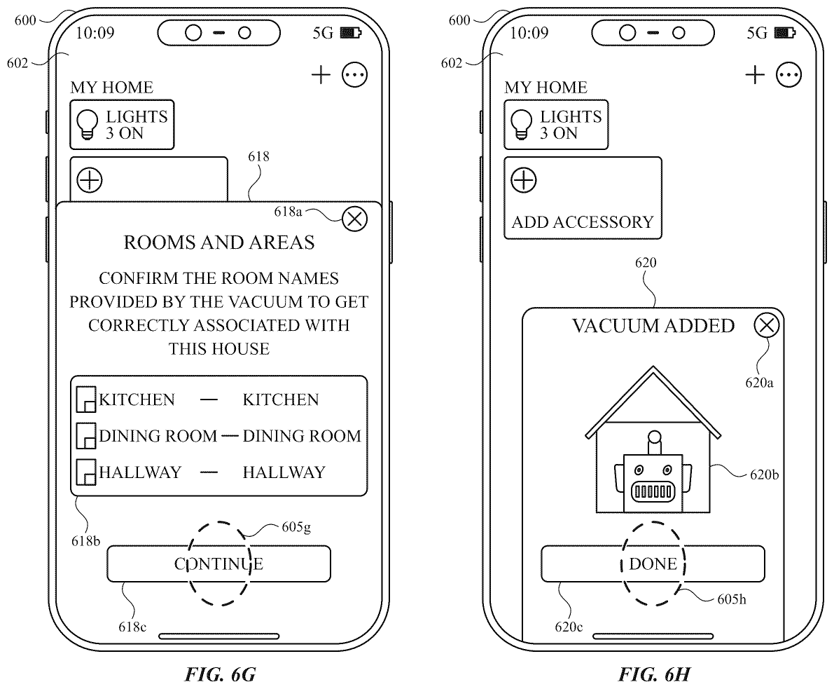

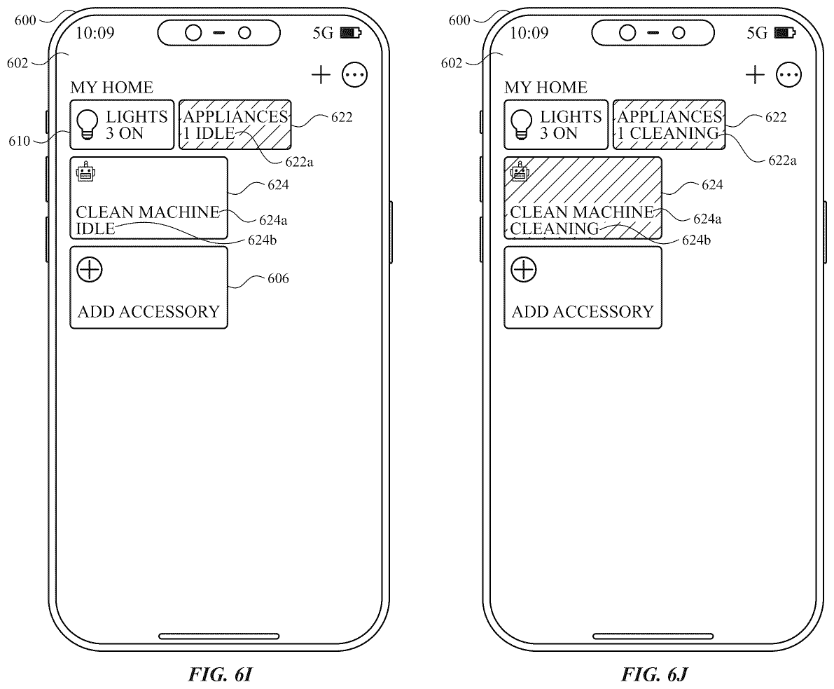

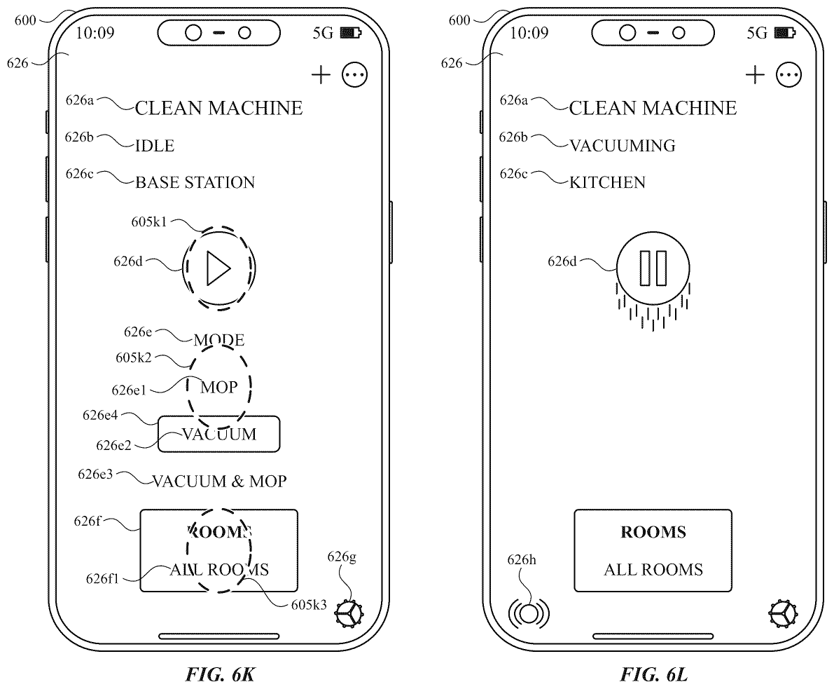

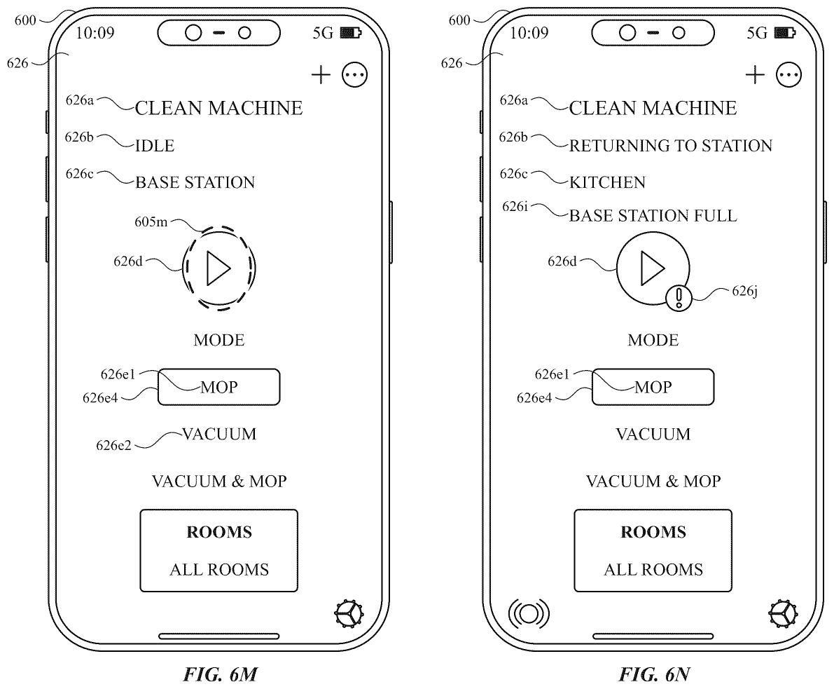

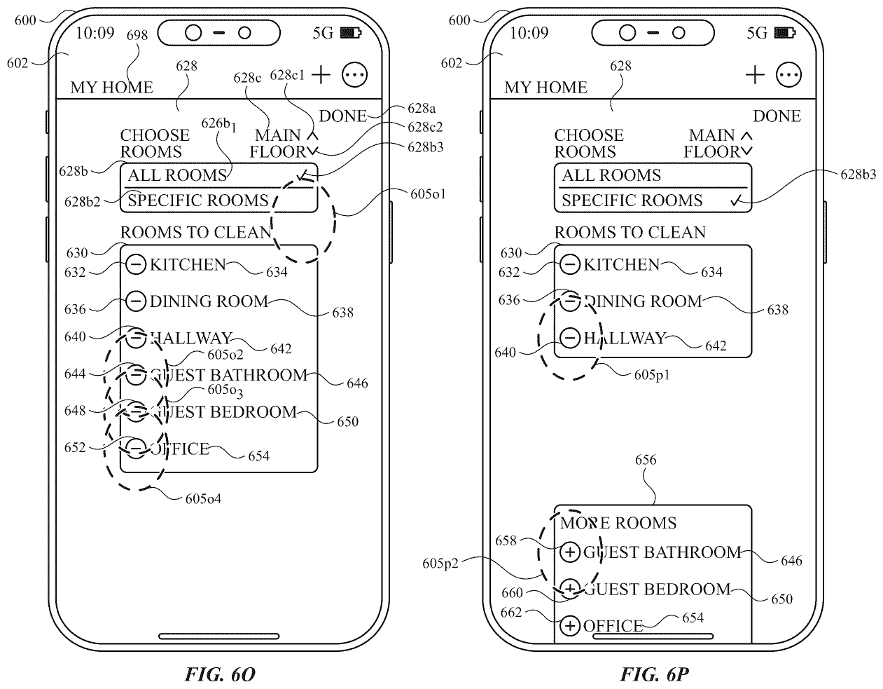

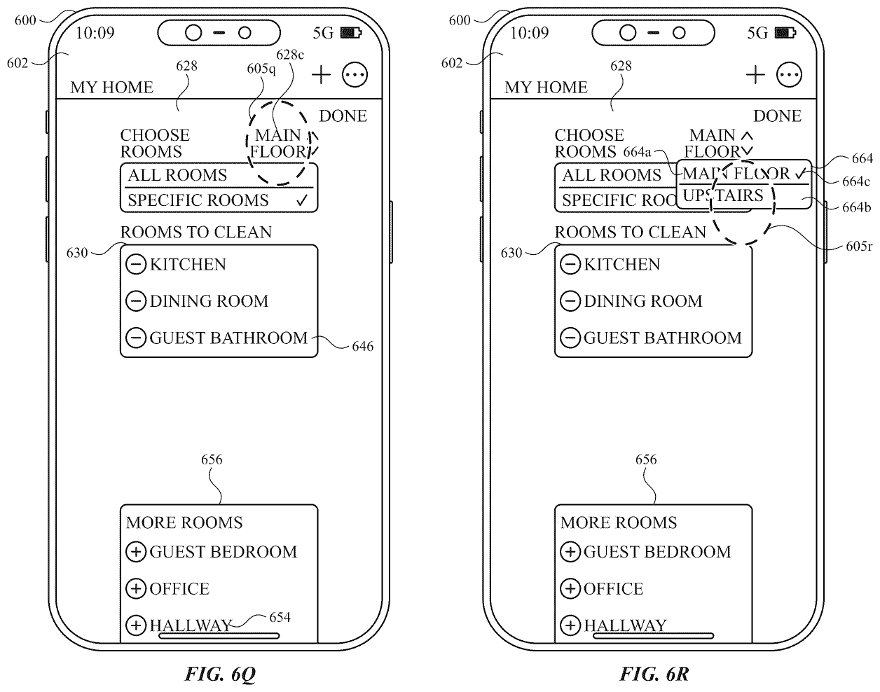

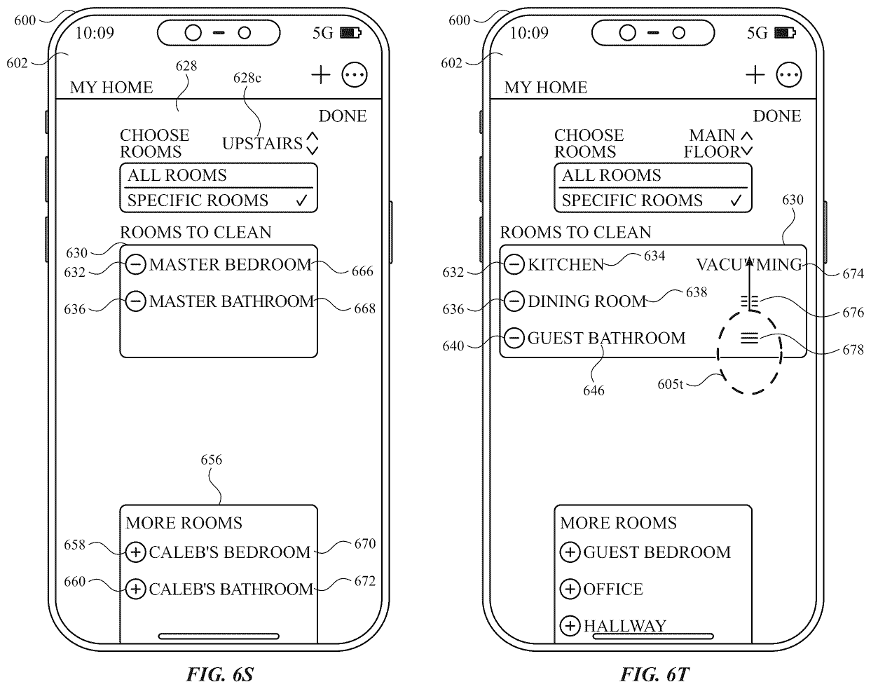

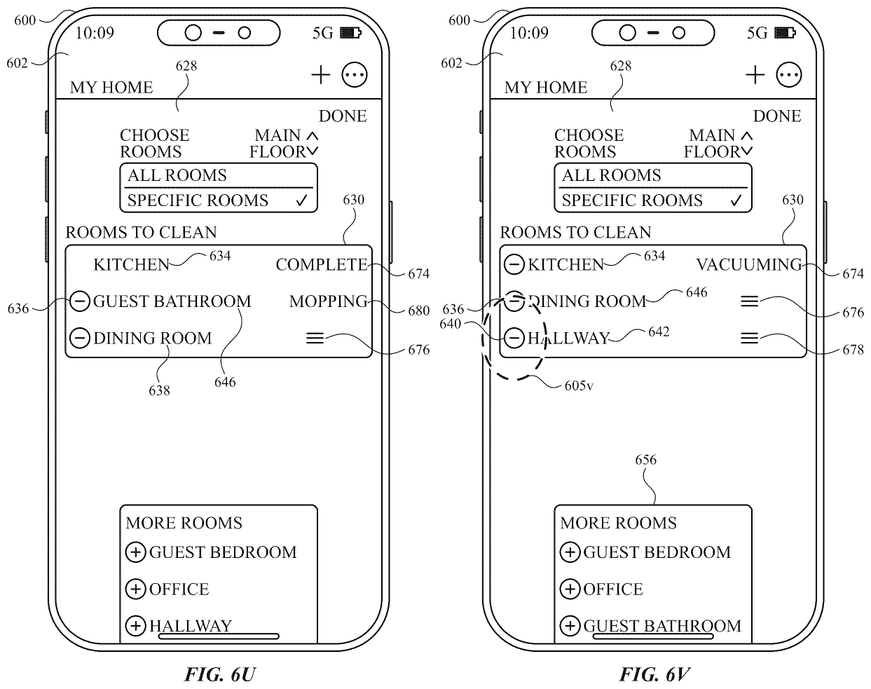

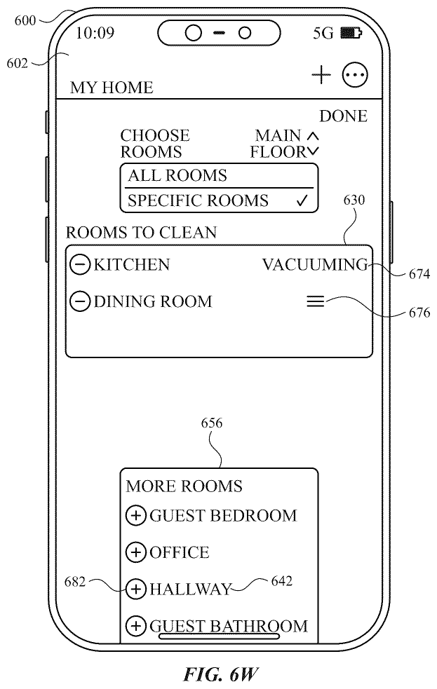

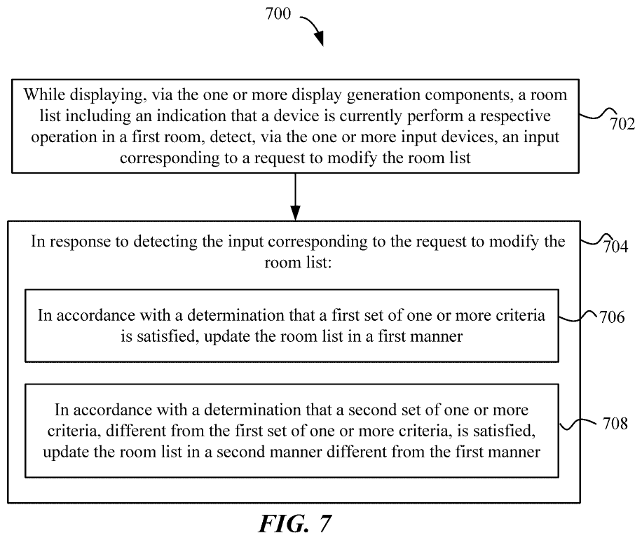

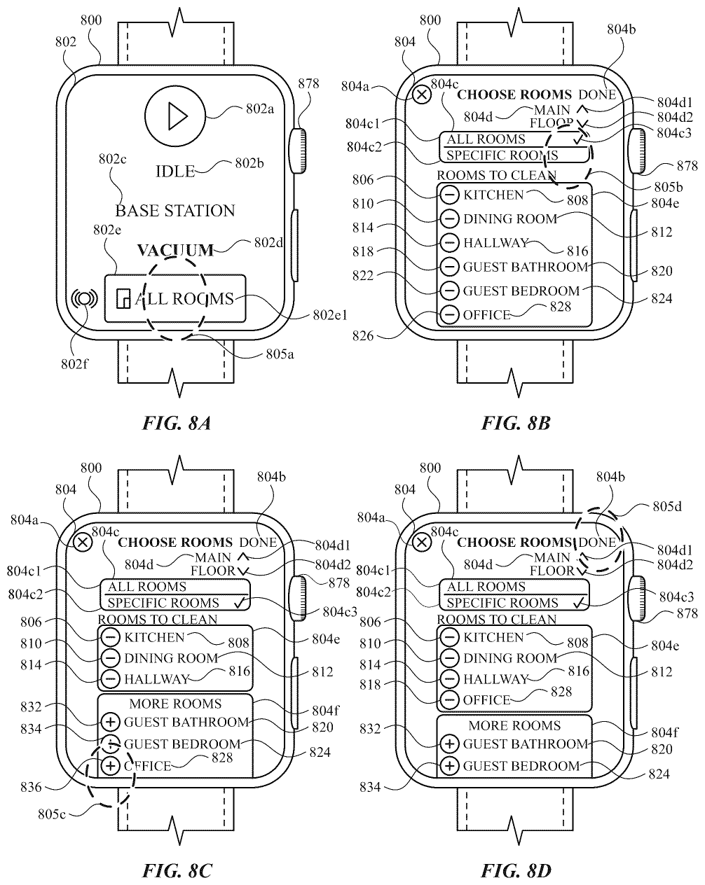

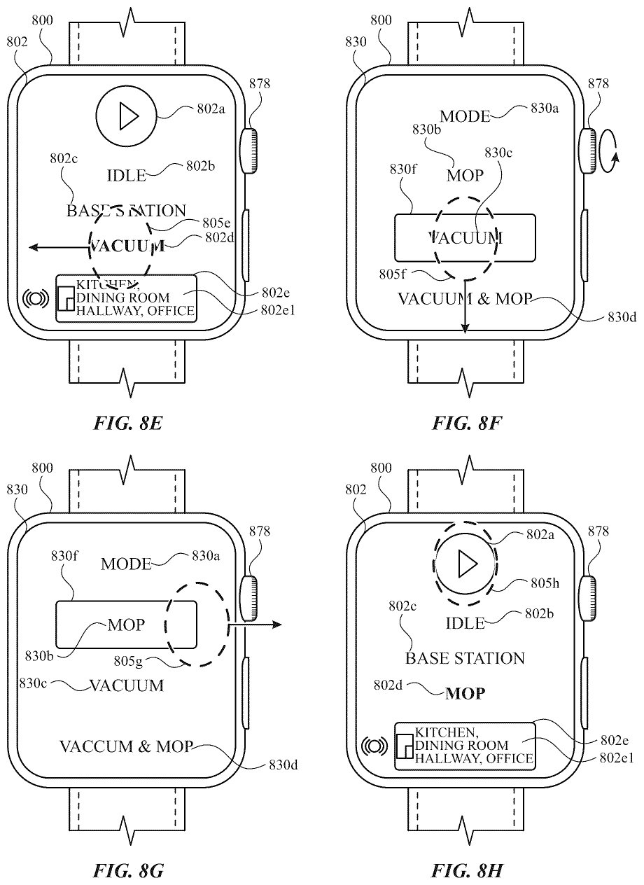

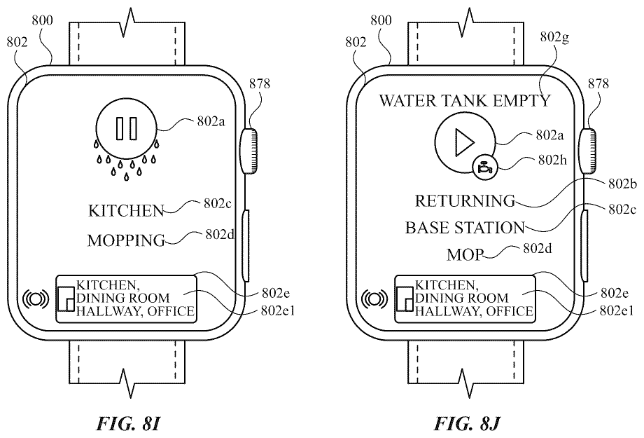

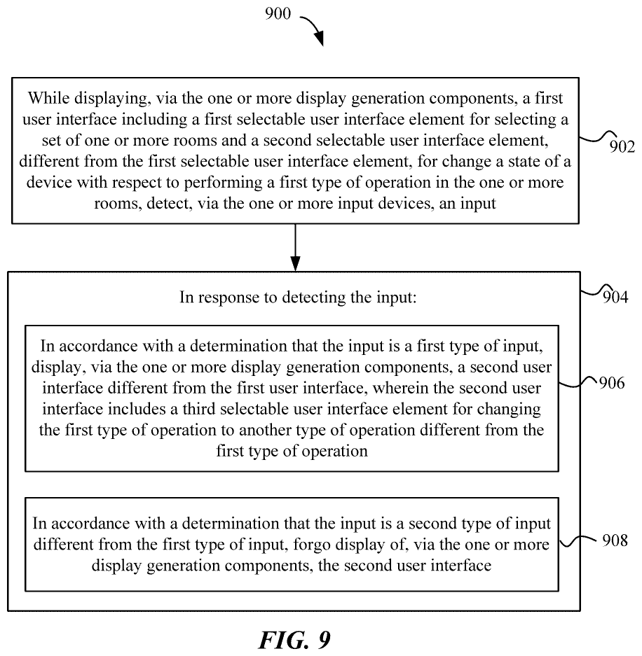

Below, FIGS. 1A-1B, 2, 3A-3G, 4A-4B, and 5A-5J provide a description of exemplary devices for performing the techniques for managing operations of a controlled device. FIGS. 6A-6W illustrate exemplary user interfaces for managing operations performed by a controlled device using a smart phone in accordance with some embodiments. FIG. 7 is a flow diagram illustrating a process for updating a room list for while a device performs one or more operations in accordance with some embodiments. The user interfaces in FIGS. 6A-6W are used to illustrate the processes described below, including the processes in FIG. 7. FIGS. 8A-8J illustrate exemplary user interfaces for managing operations performed by a controlled device using a smart watch in accordance with some embodiments. FIG. 9 is a flow diagram illustrating a process for displaying user interfaces to control a device in accordance with some embodiments. The user interfaces in FIGS. 8A-8J are used to illustrate the processes described below, including the processes in FIG. 9.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in processes described herein where one or more steps are contingent upon one or more conditions having been met, it should be understood that the described processes can be repeated in multiple repetitions so that over the course of the repetitions all of the conditions upon which steps in the process are contingent have been met in different repetitions of the process. For example, if a process requires performing a first step if a condition is satisfied, and a second step if the condition is not satisfied, then a person of ordinary skill would appreciate that the claimed steps are repeated until the condition has been both satisfied and not satisfied, in no particular order. Thus, a process described with one or more steps that are contingent upon one or more conditions having been met could be rewritten as a process that is repeated until each of the conditions described in the process has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a process until all of the conditions upon which steps in the process are contingent have been met. A person having ordinary skill in the art would also understand that, similar to a process with contingent steps, a system or computer readable storage medium can repeat the steps of a process as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

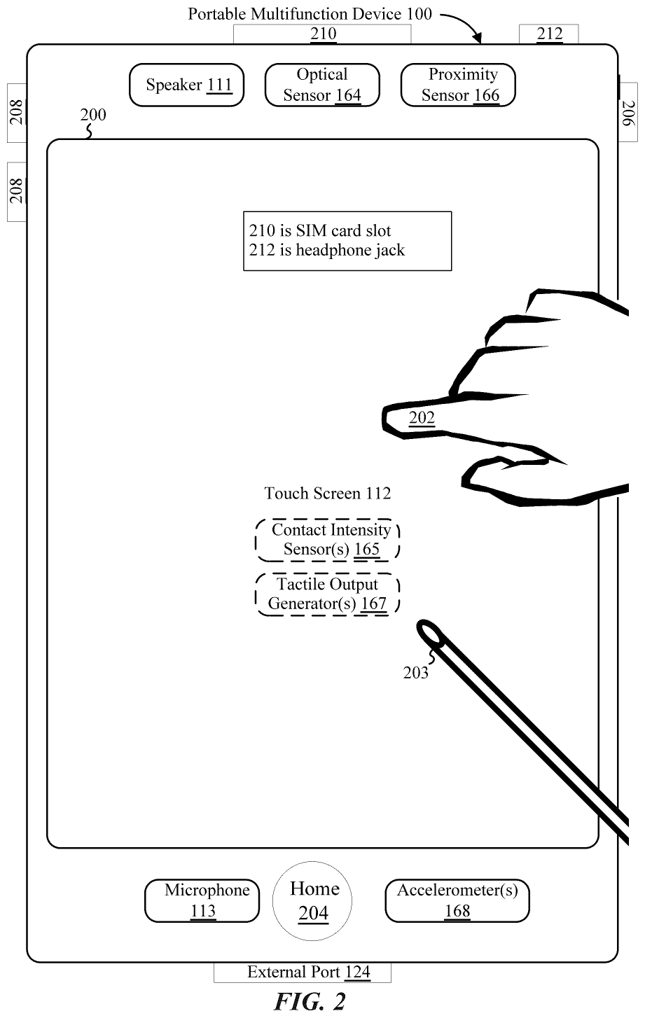

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

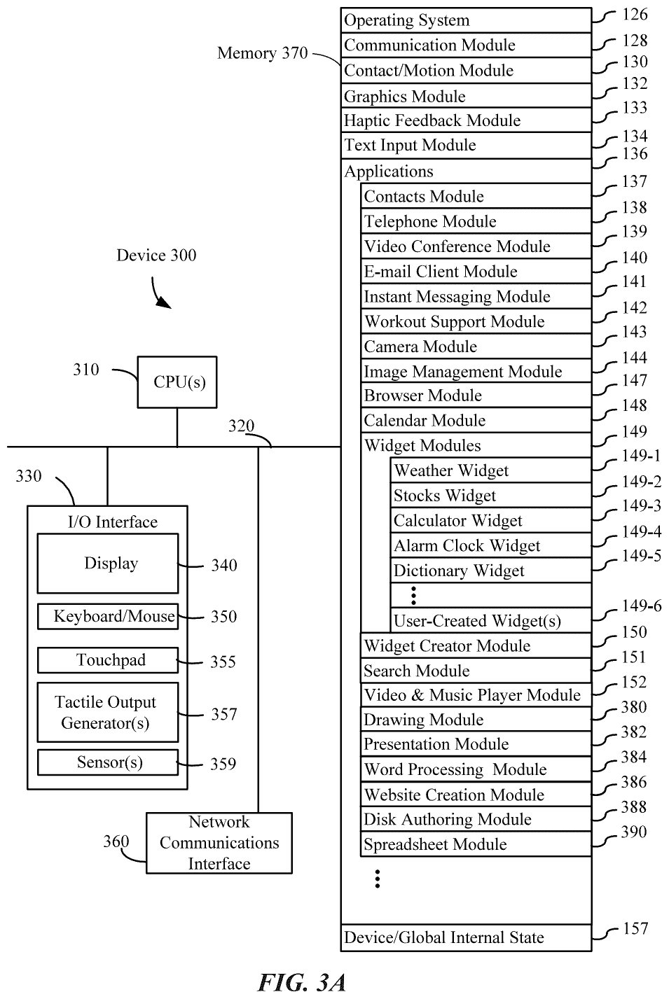

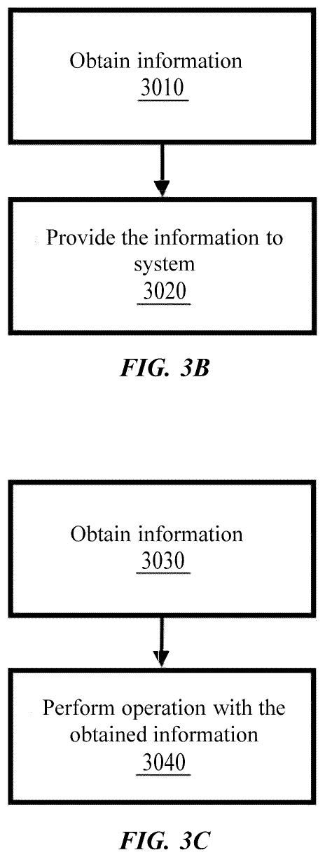

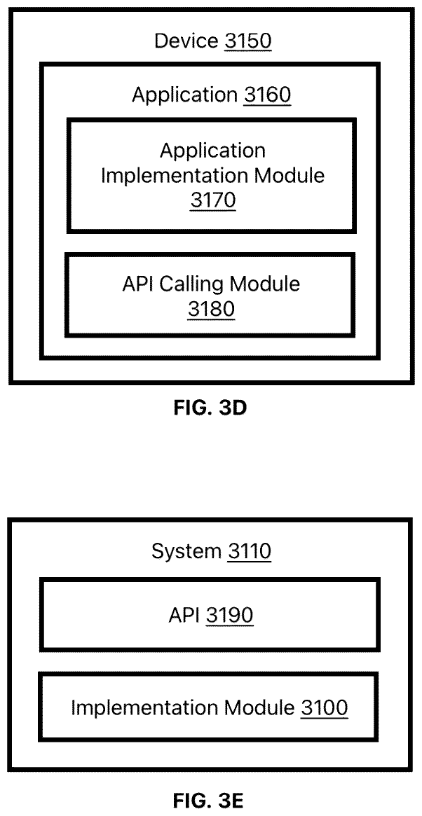

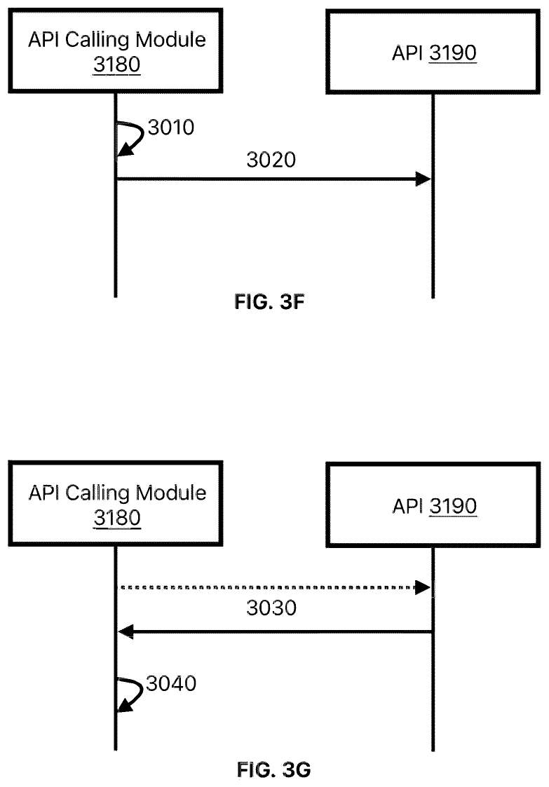

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the processes described in this application (e.g., the computer-implemented processes and other information processing processes described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits processes and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In some embodiments, application 3160 is an application that is provided to device 3150 via an operating system update file (e.g., a first party application or a second party application). In some embodiments, application 3160 is an application that is provided via an application store. In some embodiments, the application store can be an application store that is pre-installed on device 3150 at purchase (e.g., a first party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information, electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low-level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing a secure connection, such as with an accessory), a device detection API (e.g., for locating nearby devices, such as media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is a system (e.g., operating system, and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, and/or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected, the direct sensor data is frequently processed into one or more input events that are provided (e.g., via an API) to a receiving software process that makes some determination based on the input events, and then information is sent (e.g., via an API) to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is a third-party application (e.g., an application that is provided by an application store, downloaded via a network, and/or read from a storage device). In some embodiments, the application controls the first computer system to perform processes 700 and 900 (FIGS. 7 and 9) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the different module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

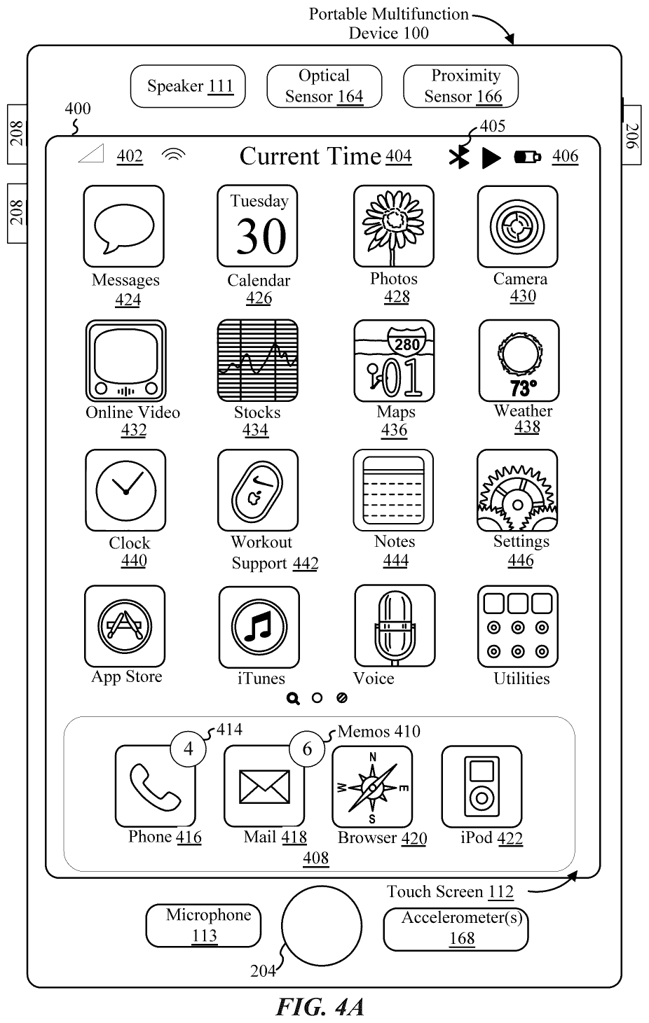

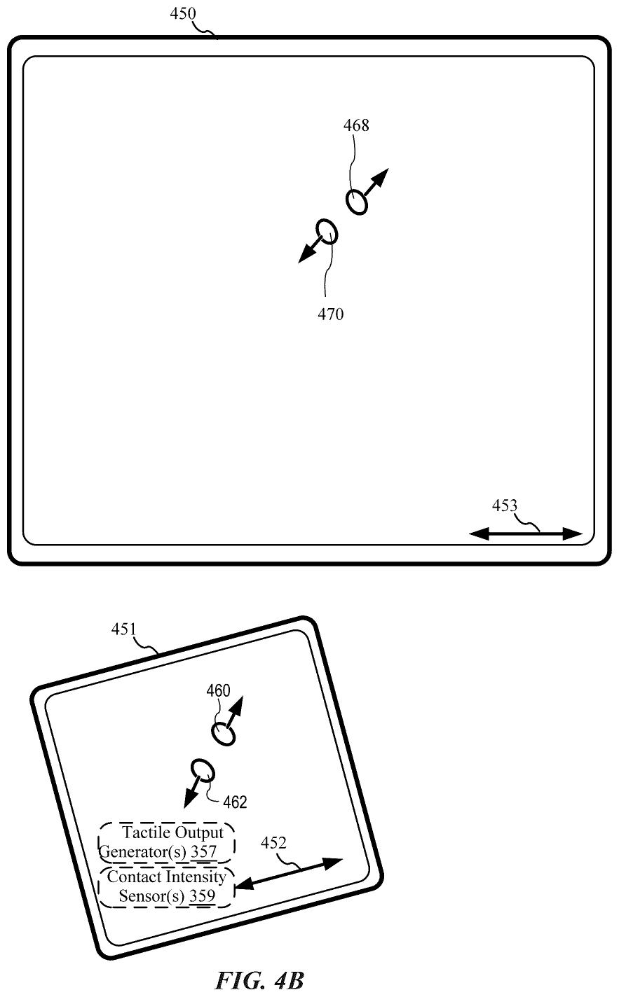

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar processes are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

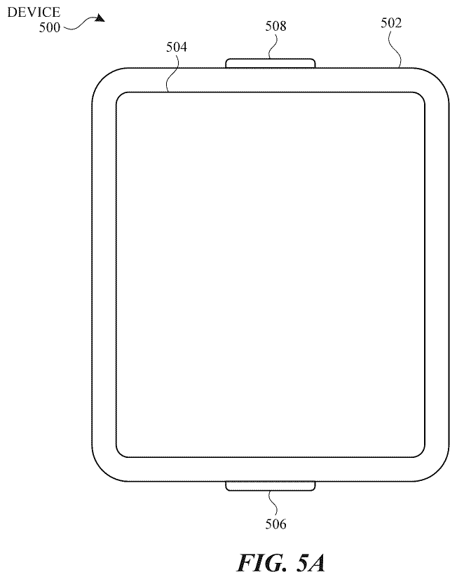

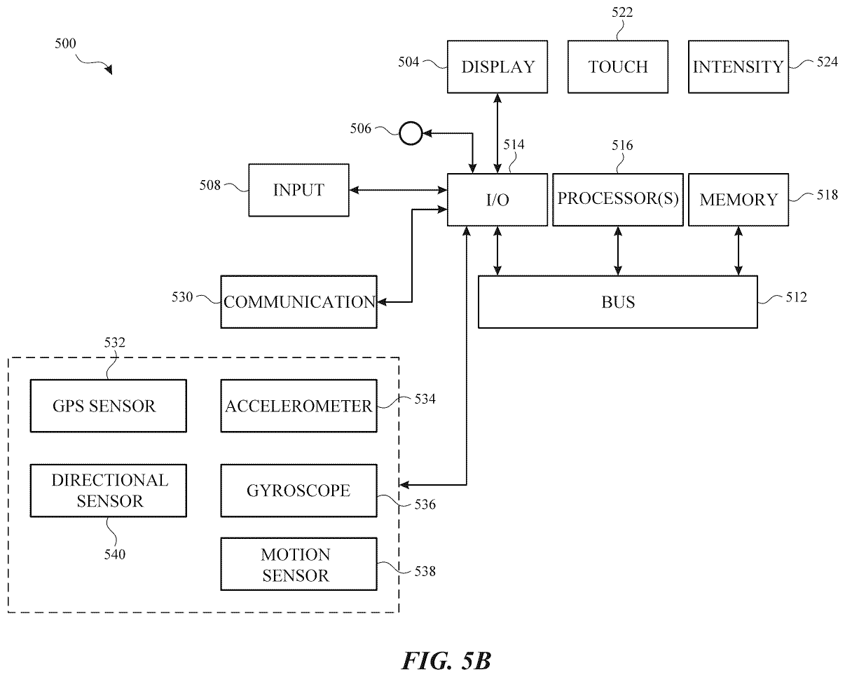

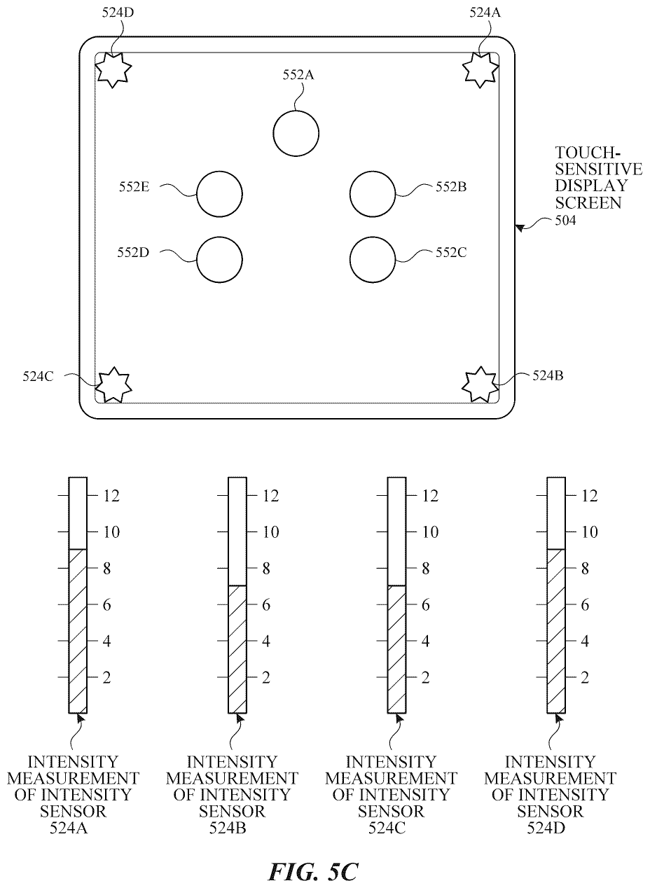

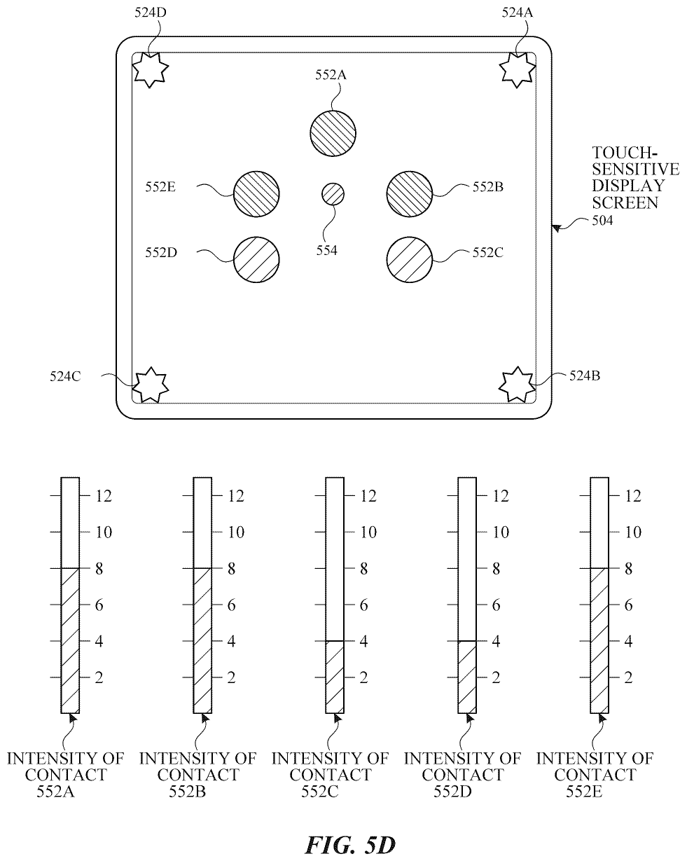

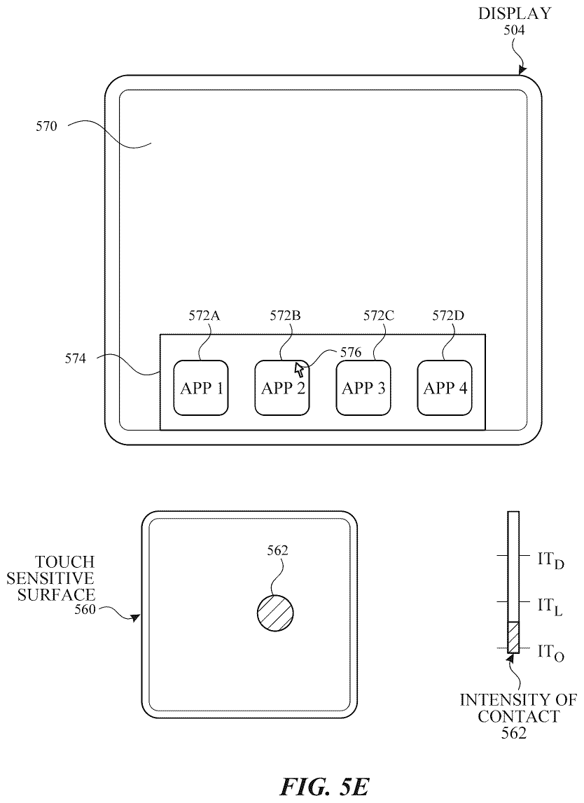

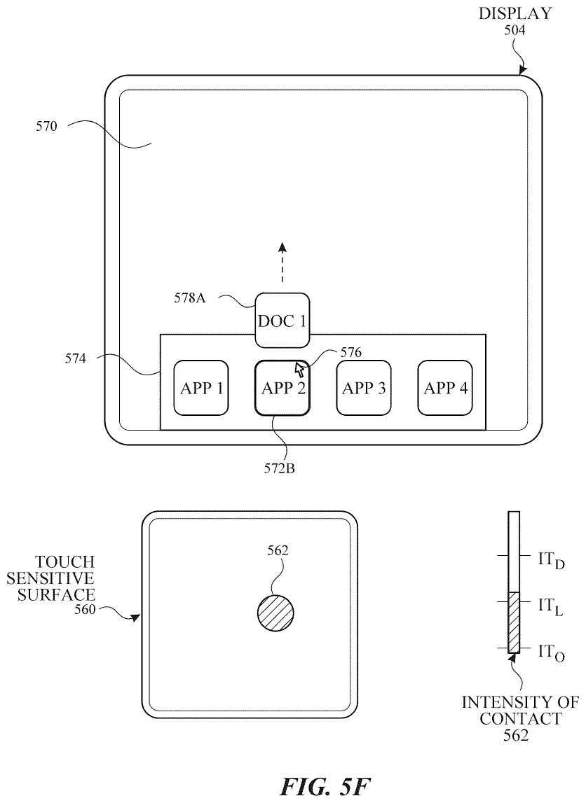

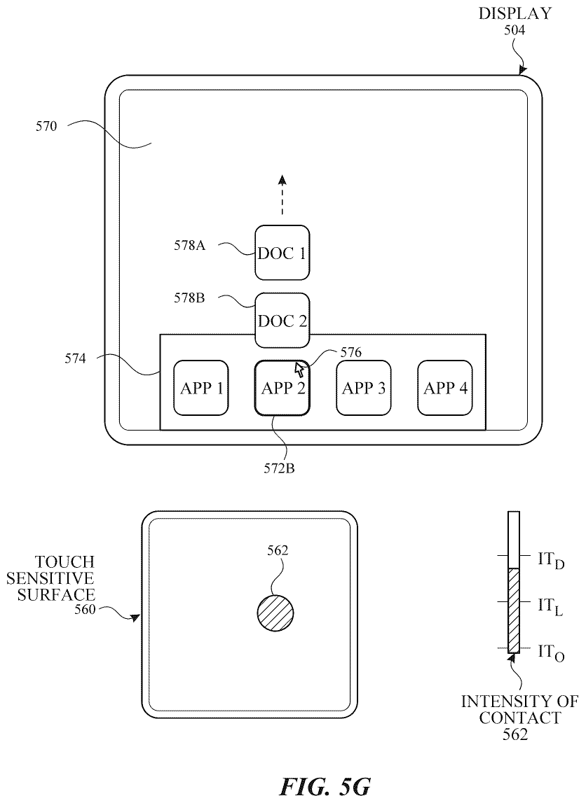

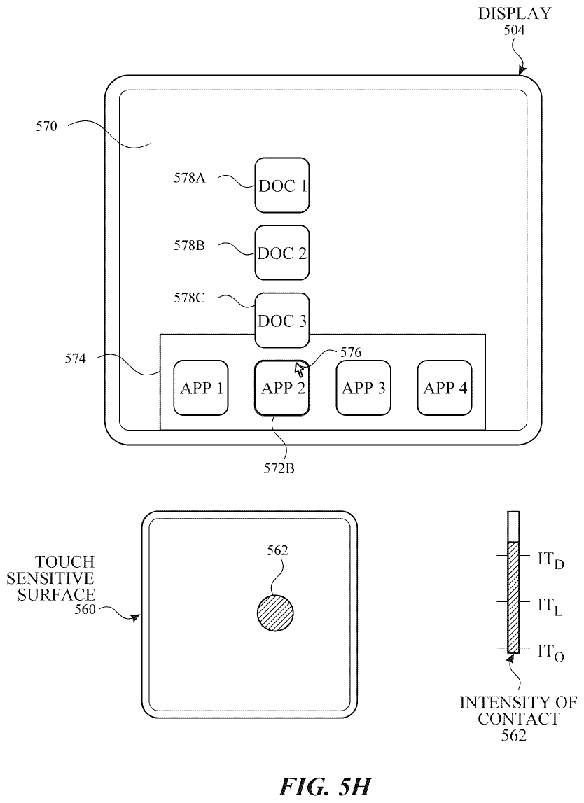

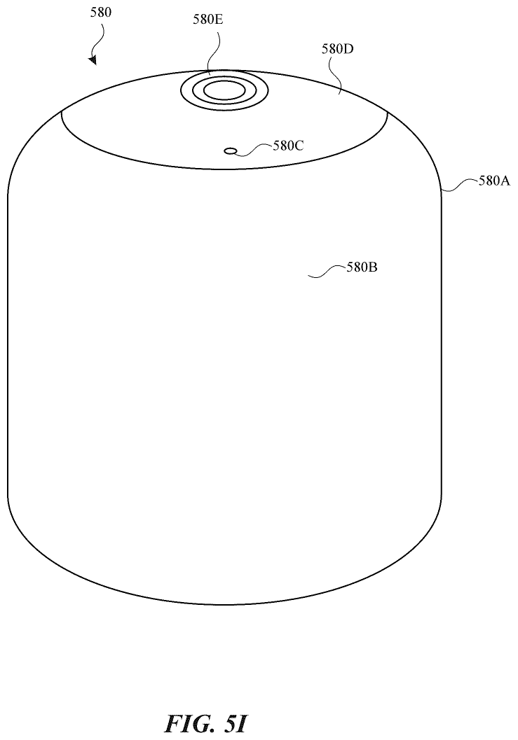

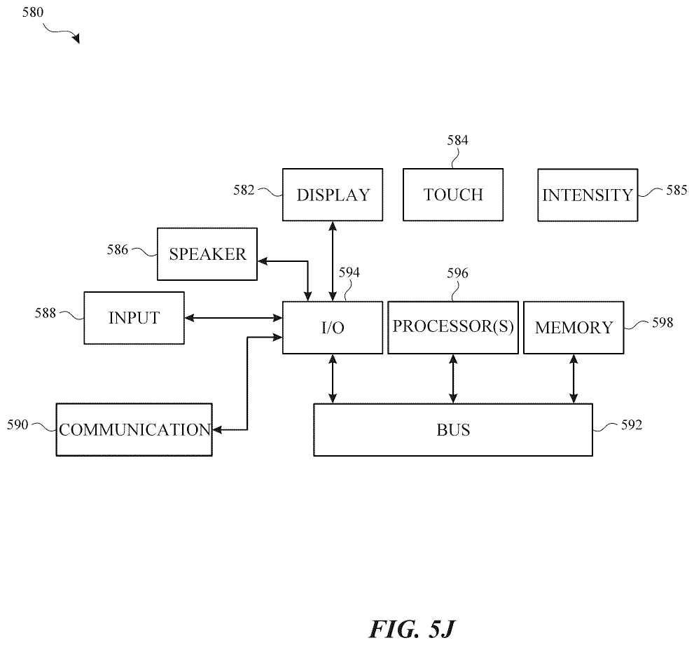

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A-3G. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700 and 900 (FIGS. 7 and 9). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A-3G, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

FIG. 5I illustrates exemplary electronic device 580. Device 580 includes body 580A. In some embodiments, device 580 can include some or all of the features described with respect to devices 100, 300, and 500 (e.g., FIGS. 1A-5B). In some embodiments, device 580 has one or more speakers 580B (concealed in body 580A), one or more microphones 580C, one or more touch-sensitive surfaces 580D, and one or more displays 580E. Alternatively, or in addition to a display and touch-sensitive surface 580D, the device has a touch-sensitive display (also referred to as a touchscreen). As with devices 100, 300, and 500, in some embodiments, touch-sensitive surface 580D (or the touch screen) optionally includes one or more intensity sensors for detecting intensity of contacts (e.g., touches) being applied. The one or more intensity sensors of touch-sensitive surface 580D (or the touchscreen) can provide output data that represents the intensity of touches. The user interface of device 580 can respond to touches based on their intensity, meaning that touches of different intensities can invoke different user interface operations on device 580. In some embodiments, the one or more displays 580E are one or more light-emitting diodes (LEDs). For example, a display can be a single LED, an LED cluster (e.g., a red, a green, and a blue LED), a plurality of discrete LEDs, a plurality of discrete LED clusters, or other arrangement of one or more LEDs. For example, the display 580E can be an array of nine discrete LED clusters arranged in a circular shape (e.g., a ring). In some examples, the one or more displays are comprised of one or more of another type of light-emitting elements.

FIG. 5J depicts exemplary personal electronic device 580. In some embodiments, device 580 can include some or all of the components described with respect to FIGS. 1A, 1B, 3A-3G, and 5A-5B. Device 580 has bus 592 that operatively couples I/O section 594 with one or more computer processors 596 and memory 598. I/O section 594 can be connected to display 582, which can have touch-sensitive component 584 and, optionally, intensity sensor 585 (e.g., contact intensity sensor). In some embodiments, touch-sensitive component 584 is a separate component than display 582. In addition, I/O section 594 can be connected with communication unit 590 for receiving application and operating system data, using Wi-Fi, Bluetooth, near field communication (NFC), cellular, and/or other wireless communication techniques. Device 580 can include input mechanisms 588. Input mechanism 588 is, optionally, a button, in some examples. Input mechanism 588 is, optionally, a microphone, in some examples. Input mechanism 588 is, optionally, a plurality of microphones (e.g., a microphone array).

Electronic device 580 includes speaker 586 for outputting audio. Device 580 can include audio circuitry (e.g., in I/O section 594) that receives audio data, converts the audio data to an electrical signal, and transmits the electrical signal to speaker 586. Speaker 586 converts the electrical signal to human-audible sound waves. The audio circuitry (e.g., in I/O section 594) also receives electrical signals converted by a microphone (e.g., input mechanism 588) from sound waves. The audio circuitry (e.g., in I/O section 594) converts the electrical signal to audio data. Audio data is, optionally, retrieved from and/or transmitted to memory 598 and/or RF circuitry (e.g., in communication unit 590) by I/O section 594.

Memory 598 of personal electronic device 580 can include one or more non-transitory computer-readable storage mediums, for storing computer-executable instructions, which, when executed by one or more computer processors 596, for example, can cause the computer processors to perform the techniques described below, including processes 700 and 900 (FIGS. 7 and 9)). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 580 is not limited to the components and configuration of FIG. 5J, but can include other or additional components in multiple configurations.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

It should be recognized that an input detected via one or more input devices can include one or more inputs, such as a selection input, a non-selection input, a movement input, a non-movement input, an air gesture input (sometimes referred to as an air gesture as described above), a non-air gesture input, a gaze input, a non-gaze input, a verbal input, and/or a non-verbal input. In some embodiments, a selection input is an input that chooses and/or selects a subject (e.g., an element, a user interface element, a user interface object, a user interface, a person, a user, an animal, an electronic device, a computer system, and/or an object) from multiple subjects or a state from multiple states. In some embodiments, a selection input specifies a subject in which to perform an operation. Examples of a selection input include a tap input, a verbal input, an audible command, a gaze input, an air gesture input, a mouse click, a squeeze input of a portion of an electronic stylus, a blink of one or more eyes of a subject, depression of rotatable input mechanism, and/or a submission of a physical hardware element. In some embodiments, a non-selection input is an input that does not correspond to a user interface element being displayed. In some embodiments, a non-selection input does not specify a subject for which to perform an operation. Examples of a non-selection input include a verbal input, an audible request, an audible command, an audible statement, a movement input, a hold-and-drag input, a gaze input, an air gesture input, and/or a mouse movement. In some embodiments, a movement input is an input that starts at a first position and moves to a second position different from the first position. In such embodiments, the movement input can end at the second position or move back to the first position. Examples of a movement input include a swipe gesture input, a flick gesture input, movement of a subject, movement of a mouse, movement of an input on a touch-sensitive surface, an air gesture moving from one location to another, rotation of a physical input mechanism, and/or rotation of an electronic stylus. In some embodiments, a non-movement input is an input that does not start at a first position and move to a second position different from the first position before ending at the second position or moving back to the first position. Examples of a non-movement input include a verbal input, an audible request, an audible command, an audible statement, a tap input, a hold-and-drag input, a gaze input, an air gesture input, mouse movement, and/or a mouse click. Examples of an air gesture input include a hand gesture to pick up, a hand gesture to press, an air-tap gesture, an air-swipe gesture, an air pinch gesture, air de-pinch gesture, a tap-and-hold air gesture, a hand rotation, and/or a clench-and-hold air gesture. In some embodiments, multiple inputs are combined to represent a single input, such as an air gesture input combined with a selection input where the air gesture input or the gaze input identifies a target and the selection input determines when the target should be identified.

Attention is now directed towards embodiments of user interfaces (“UI”) and associated processes that are implemented on an electronic device, such as portable multifunction device 100, device 300, or device 500.

FIGS. 6A-6W illustrate exemplary user interfaces for managing operations of a controlled device using a smart phone in accordance with some embodiments. The user interfaces in these figures are used to illustrate the processes described below, including the processes in FIG. 7.

FIGS. 6A-6W illustrate computer system 600 as a smart phone. It should be recognized that computer system 600 can be other types of computer systems, such as a smart watch, a tablet, a laptop, a desktop, a communal device, an accessory, a laptop computer, a fitness tracking device, and/or a head-mounted display (HMD) device.

FIGS. 6A-6H illustrate a process for connecting to a controlled device. Connecting to the controlled device can allow computer system 600 to display data regarding the use of the controlled device and/or controls that allow a user to view, interact with, and/or manage the controlled device. In some embodiments, the controlled device is a mobile controlled device, such as a robot, a vacuum, and/or a mop.

As illustrated in FIG. 6A, computer system 600 displays user interface 602 (e.g., a landing page corresponding to a home application). In some embodiments, user interface 602 is displayed in response to detecting an input directed to an icon for the home application within a home screen and/or a list of applications. In some embodiments, the home application is an application that can be connected with (e.g., tied to, assigned to, and/or linked to) a physical address (e.g., a home, a house, an apartment, an office, a hotel, and/or another type of location) and/or a set of one or more accessory devices (sometimes referred to as the home). When connected with the physical address and/or the set of one or more accessory devices, computer system 600 displays, via one or more user interfaces of the home application, controls that allow the user to view, interact with, and/or manage the physical address through use of the set of one or more accessory devices, external data, and/or automated systems. It should be recognized that user interface 602 can be navigated to in other ways, such as a voice request to display user interface 602 and/or different sets of inputs.

As illustrated in FIG. 6A, user interface 602 includes home name indicator 698, accessory control 604, and add accessory control 606. In some embodiments, home name indicator 698 indicates a name (e.g., a default name for the home, such as “My home”) of the home connected to the home application. It should be recognized that the name of the home can be user-created, such as “John's Home”, “123 Oak Street”, and/or “Appleseed Family Home”. In some embodiments, when connected to another home, home name indicator 698 indicates the name of that home. In some embodiments, in response to detecting an input directed to accessory control 604, computer system 600 displays user interface elements corresponding to one or more lighting accessories as part of user interface 602 and/or controls the one or more lighting accessories. In some embodiments, in response to detecting an input directed to add accessory control 606, computer system 600 initiates a process for adding an accessory. It should be recognized that more, fewer, and/or different elements can be included in user interface 602.

At FIG. 6A, computer system 600 detects selection input 605a directed to add accessory control 604. In some embodiments, selection input 605a is a tap input on add accessory control 604. It should be recognized that selection input 605a can be other types of inputs such as a voice command requesting to add an accessory.

FIG. 6B illustrates a scenario following FIG. 6A where computer system 600 adds a controlled device detected within a field-of-view of a camera of computer system 600 to the home application. As illustrated in FIG. 6B, in response to detecting selection input 605a, computer system 600 displays user interface 608 (e.g., a connection user interface) as overlaid over user interface 602. User interface 608 includes exit control 608a, more options control 608b, field-of-view 608c, description region 608e, and description region 608f. In some embodiments, in response to detecting an input directed to exit control 608a, computer system 600 ceases display of user interface 608. In some embodiments, in response to detecting an input directed to more options control 608b, computer system 600 displays various other options for adding an accessory to the home application. In some embodiments, field-of-view 608c indicates a live feed detected by a camera belonging to computer system 600. As illustrated in FIG. 6B, the live feed includes QR code 608d (e.g., a QR code corresponding to a controlled device), and computer system 600 detects QR code 608d as indicated by detection indicator 608cl (e.g., a visual frame surrounding QR code 608d). In some embodiments, description region 608e includes a description informing the user of one method (e.g., “Scan a QR code”) to add an accessory to the home application. In some embodiments, description region 608f includes a description informing the user of another method (e.g., “Hold device near accessory”) to add an accessory to the home application. At FIG. 6B, in response to detecting QR code 608d, computer system 600 initiates a connection process to the detected controlled device.

FIGS. 6C-6D illustrate a process to install an application corresponding to a controlled device. In some embodiments, the process is initiated in response to scanning a QR code and when (1) the controlled device corresponding to the QR code requires an application associated with the controlled device be installed and (2) the application is not installed on computer system 600. It should be recognized that the process is just an example and that other processes for installing an application can be used with techniques described herein. It should also be recognized that FIGS. 6C-6D can be skipped when (1) the controlled device corresponding to the QR code does not require an application associated with the controlled device be installed and/or (2) the application is already installed on computer system 600.

As illustrated in FIG. 6C, computer system 600 displays user interface 610 (e.g., an application connection user interface) as overlaid over user interface 602. User interface 610 includes logo indicator 610a (e.g., a logo corresponding to the application), open control 610b, dismiss control 610c, and exit control 610d. In some embodiments, in response to detecting an input directed to open control 610b, computer system 600 exits the home application (e.g., ceases display of user interface 602) and displays an application store user interface. In some embodiments, in response to detecting an input directed to dismiss control 610c, computer system 600 ceases display of user interface 610. In some embodiments, in response to detecting an input directed to exit control 610d, computer system 600 ceases display of user interface 610. It should be recognized that more, fewer, and/or different elements can be included in user interface 610. At FIG. 6C, computer system 600 detects selection input 605c directed to open control 610b. In some embodiments, selection input 605c is a tap input on open control 610b.

As illustrated in FIG. 6D, in response to detecting selection input 605c, computer system 600 exits the home application (e.g., ceases display of user interface 602) and displays user interface 612 (e.g., an application store user interface). User interface 612 displays information corresponding to an application that, when downloaded, allows the user to control and/or manage interactions with a controlled device. Additionally, user interface 612 includes download control 612a. In some embodiments, in response to detecting an input directed to download control 612a, computer system 600 downloads the application corresponding to user interface 610 (e.g., a controlled device management application). In some embodiments, the application corresponding to user interface 612 allows a user to control a controlled device within the application (e.g., as opposed to controlling the controlled device within the home application). It should be recognized that more, fewer, and/or different elements can be included in user interface 612. At FIG. 6D, computer system 600 detects selection input 605d directed to download control 612a. In some embodiments, selection input 605d is a tap input on download control 612a.

FIG. 6E illustrates a scenario following FIGS. 6B and/or 6D where computer system 600 initiates a connection process, connecting the added controlled device to the home. As illustrated in FIG. 6E, as part of the connection process, computer system 600 displays user interface 614 (e.g., a location setting user interface) as overlaid on user interface 602. User interface 614 includes exit control 614a, room list 614b, continue control 614m, identify control 614n, and selection indicator 6140. It should be recognized that more, fewer, and/or different elements can be included in user interface 614.

In some embodiments, in response to detecting an input directed to exit control 614a, computer system 600 ceases display of user interface 614. Room list 614b includes a list of rooms that correspond to the home connected to the home application. Room list 614b includes room indicator 614c (e.g., “Master Bedroom”), room indicator 614d (e.g., “Master Bathroom”), room indicator 614e (e.g., “Caleb's Bedroom”), room indicator 614f (e.g., “Caleb's Bathroom”), room indicator 614g (e.g., “Kitchen”), room indicator 614h (e.g., “Dining room”), room indicator 614i (e.g., “Hallway”), room indicator 614j (e.g., “Guest Bathroom”), room indicator 614k (e.g., “Guest Bedroom”), and room indicator 614l (e.g., “Office”). For the purposes of the illustrated embodiment, room indicators 614c-f are upstairs in the home and room indicators 614g-l are downstairs (e.g., the main floor) in the home.

In some embodiments, in response to detecting an input directed to continue control 614m, computer system 600 continues the connection process (e.g., computer system 600 ceases display of user interface 614 and displays the next step in the connection process). In some embodiments, in response to detecting an input directed to identify control 614n, computer system 600 causes the controlled device to output content. For example, the controlled device can output a notification (e.g., a noise, an alert, and/or a push notification). This can assist the user in identifying which controlled device (e.g., of multiple controlled devices) is being added with inputs at user interface 614.

In some embodiments, computer system 600 displays selection indicator 6140 to indicate which room in room list 614b is selected for the base location for the controlled device (e.g., where the base station for the controlled device will be situated). As illustrated in FIG. 6E, selection indicator 6140 is displayed over room indicator 614g (e.g., “Kitchen”) to indicate that the kitchen is the selected base location for the controlled device. In response to detecting a swipe input directed to room list 614b and/or a tap input directed to another one of room indicators 614a-f, computer system 600 changes the selected base location for the controlled device. For example, in response to detecting an upward swipe input and/or a tap input directed to room list 614b, computer system 600 can display selection indicator 6140 over room indicator 614h (e.g., “Dining room”), indicating that the dining room is now where the base station will be located for the controlled device. At FIG. 6E, computer system 600 detects selection input 605e directed to continue control 614m. In some embodiments, selection input 605e is a tap input on continue control 614m.

As illustrated in FIG. 6F, in response to detecting selection input 605e, computer system 600 ceases display of user interface 614 and displays user interface 616 (e.g., a naming user interface) as overlaid on user interface 602. User interface 616 includes entry field 616a, continue control 616b, identify control 616c, and exit control 616d. It should be recognized that more, fewer, and/or different elements can be included in user interface 616.

In some embodiments, in response to detecting inputs directed to a keyboard, computer system 600 displays an entered name to be assigned to the controlled device within entry field 616a. Entry field 616a includes name indicator 616a1 (e.g., “Clean Machine”) and exit control 616a2. In some embodiments, in response to detecting an input directed to exit control 616a2, computer system 600 removes (e.g., deletes, cuts, and/or cancels) an entered name within entry field 616a. In some embodiments, in response to detecting an input directed to continue control 616b, computer system 600 continues the connection process (e.g., computer system 600 ceases display of user interface 616 and displays the next step in the connection process). In some embodiments, in response to detecting an input directed to identify control 616c, computer system 600 causes the controlled device to output content. For example, the controlled device can output a notification (e.g., a noise, an alert, and/or a push notification). This can assist the user in identifying which controlled device (e.g., of multiple controlled devices) is being added with inputs at user interface 616. In some embodiments, in response to detecting an input directed to exit control 616d, computer system 600 ceases display of user interface 616. At FIG. 6F, computer system 600 detects selection input 605f directed to continue control 616b. In some embodiments, selection input 605f is a tap input on continue control 616b.

As illustrated in FIG. 6G, in response to detecting selection input 605f, computer system 600 ceases display of user interface 616 and displays user interface 618 (e.g., a naming user interface) as overlaid on user interface 602. User interface 618 includes exit control 618a, room name region 618b, and continue control 618c. In some embodiments, in response to detecting an input directed to exit control 618a, computer system 600 ceases display of user interface 618. In some embodiments, room name region 618b indicates names assigned to rooms in the home connected to the home application. In some embodiments, in response to detecting an input directed to room name region 618b, computer system 600 allows the user to change the names of rooms in the home connected to the home application. This can assist the user in correlating the rooms as identified in the home application with the room as identified in the controlled device management application. Accordingly, user interactions with respect to rooms in the home application can be correlated with respective rooms in the controlled device management application, and requests made with respect to the rooms in the home application can be fulfilled with respect to the respective rooms in the controlled device management application. In some embodiments, in response to detecting an input directed to continue control 618c, computer system 600 continues the connection process (e.g., computer system 600 ceases display of user interface 618 and displays the next step in the connection process). At FIG. 6G, computer system 600 detects selection input 605g directed to continue control 618c. In some embodiments, selection input 605g is a tap input on continue control 618c.

As illustrated in FIG. 6H, in response to detecting selection input 605g, computer system 600 ceases display of user interface 618 and displays user interface 620 (e.g., a connection completion user interface) as overlaid on user interface 602. User interface 620 includes exit control 620a, graphic indicator 620b, and done control 620c. In some embodiments, in response to detecting an input directed to exit control 620a, computer system 600 ceases display of user interface 620. In some embodiments, computer system 600 displays graphic indicator 620b to indicate a successful connection to the controlled device. In some embodiments, in response to detecting an input directed to done control 620c, computer system 600 ceases display of user interface 620. It should be recognized that more, fewer, and/or different elements can be included in user interface 620. At FIG. 6H, computer system 600 detects selection input 605h directed to done control 620c.

As illustrated in FIG. 6I, in response to detecting selection input 605h, computer system 600 ceases display of user interface 620 and maintains display of user interface 602. Additionally, as illustrated in FIG. 6I, computer system 600 displays accessory control 622 and controlled device control 624 as part of user interface 602 as a result of successfully connecting to the controlled device. It should be noted that accessory control 622 was not included in user interface 602 before the controlled device was connected to the home application. It should be recognized that if other appliances (e.g., other controlled devices) were already connected to the home application before connecting the controlled device, accessory control 622 would be displayed before the controlled device was connected to the home application and would be updated to indicate that the controlled device was connected (e.g., indicating that the home includes multiple appliances).

In some embodiments, in response to detecting an input directed to accessory control 622, computer system 600 displays user interface elements corresponding to a controlled device (e.g., controlled device control 624) as part of user interface 602. As illustrated in FIG. 6I, accessory control 622 is displayed with hatching to indicate user interface elements corresponding to the controlled device are included in user interface 602. Additionally, as illustrated in FIG. 6I, accessory control 622 includes status indicator 622a. In some embodiments, computer system 600 displays status indicator 622a to indicate the status of the controlled device (e.g., whether the controlled device is active, inactive, and/or what operation it is performing).

In some embodiments, in response to detecting an input directed to controlled device control 624, computer system 600 ceases display of user interface 602 and displays a controlled device user interface (e.g., a user interface that includes management controls that allow the user to view, interact with and/or manage a controlled device). Additionally, as illustrated in FIG. 6I, controlled device control 624 includes name indicator 624a (e.g., “Clean Machine” and status indicator 624b. In some embodiments, computer system 600 displays status indicator 624b to indicate the status of the controlled device (e.g., whether the controlled device is active, inactive, and/or what operation it is performing).

It should be recognized that FIG. 6J occurs at a time after FIG. 6I. As illustrated in FIG. 6J, computer system 600 displays status indicator 622a as “1 cleaning” and status indicator 624b as “cleaning”, indicating that the controlled device is active. Additionally, controlled device control 624 is displayed with hatching, also indicating that the controlled device is active. In some embodiments, the controlled device activates automatically (e.g., due to a timer and/or free of input). In some embodiments, the controlled device becomes active in response to an input (e.g., a tap input and/or a voice command).

FIGS. 6K-6N illustrate a process for interacting with a controlled device. As illustrated in FIG. 6K, computer system 600 displays user interface 626 (e.g., a controlled device user interface). In some embodiments, user interface 626 is displayed in response to detecting an input directed to controlled device control 624 (e.g., in FIG. 6I or 6J). User interface 626 includes name indicator 626a (e.g., Clean Machine), status indicator 626b, location indicator 626c, play/pause control 626d, mode indicator 626e, mop indicator 626e1, vacuum indicator 626e2, mop and vacuum indicator 626e3, selection indicator 626e4, rooms region 626f, selected rooms indicator 626f1, and settings control 626g. As illustrated in FIG. 6K, computer system 600 displays play/pause control 626d as a selectable user interface element with the appearance of a triangle (e.g., a play symbol). It should be recognized that more, fewer, and/or different elements can be included in user interface 626.

In some embodiments, computer system 600 displays status indicator 626b to indicate the status of the controlled device (e.g., whether the controlled device is active, inactive, and/or what operation it is performing). In some embodiments, computer system 600 displays location indicator 626c to indicate the current location of the controlled device. As illustrated in FIG. 6K, status indicator 626b is displayed as “Idle”, indicating that the controlled device is inactive (e.g., is not performing an operation). In some embodiments, computer system 600 displays location indicator 626c to indicate the location of the controlled device. As illustrated in FIG. 6K, location indicator 626c is displayed as “Base station”, indicating that the controlled device is located at the base station.

In some embodiments, in response to detecting an input directed to play/pause control 626d, computer system 600 sends a signal to the controlled device to activate and/or deactivate. For example, in response to detecting an input to play/pause control 626d while the controlled device is inactive (e.g., the symbol of play/pause control 626d is play), computer system 600 sends a signal to the controlled device to tell it to activate (e.g., play and/or start). As another example, in response to detecting an input to play/pause control 626d while the controlled device is active (e.g., the symbol of play/pause control is pause), computer system 600 sends a signal to the controlled device to tell it to deactivate (e.g., pause and/or stop). In some embodiments, when the controlled device is paused, after a certain amount of time, the controlled device can return to the base station.

In some embodiments, computer system 600 displays mode indicator 626e to indicate the mode (e.g., type of operation) that the controlled device will enter upon activation. As illustrated in FIG. 6K, user interface 626 includes three modes: mop indicator 626e1, vacuum indicator 626e2, and mop-and-vacuum indicator 626e3. As illustrated in FIG. 6K, each of mop indicator 626e1, vacuum indicator 626e2, and mop-and-vacuum indicator 626e3 is displayed as a selectable user interface element. In some embodiments, in response to detecting an input directed to mop indicator 626e1, computer system 600 designates mopping as the operation the controlled device will perform upon activation. In some embodiments, in response to detecting an input directed to vacuum indicator 626e2, computer system 600 designates vacuuming as the operation the controlled device will perform upon activation. In some embodiments, in response to detecting an input directed to mop-and-vacuum indicator 626e3, computer system 600 designates mopping and vacuuming as the operation the controlled device will perform upon activation. In some embodiments, computer system 600 displays selection indicator 626e4 to indicate which mode is selected (e.g., which operation the controlled device will perform upon activation). As illustrated in FIG. 6K, selection indicator 626e4 is displayed over vacuum indicator 626e2, indicating that the controlled device will perform a vacuuming operation upon activation.

In some embodiments, computer system 600 displays rooms region 626f as a selectable user interface element and to include selected rooms for the controlled device to perform an operation in. In some embodiments, computer system 600 displays selected rooms indicator 626f1 to indicate what rooms are selected for the controlled device to perform an operation in. As illustrated in FIG. 6K, selected rooms indicator 626f1 is displayed as “All rooms”, indicating that the controlled device will perform the selected operation (e.g., in this case, vacuuming as indicated by selection indicator 626e4) in all rooms in the home. In some embodiments, rooms region 626f includes specific rooms rather than all rooms. For example, in a scenario where only the kitchen is selected for the controlled device to operate in, selected rooms indicator 626f1 is displayed as “Kitchen”, indicating that the controlled device will perform the selected operation only in the kitchen. In some embodiments, in response to detecting an input directed to settings control 626g, computer system 600 ceases display of user interface 626 and displays a settings user interface.

It should be recognized that the following figures are presented as different scenarios in response to computer system 600 detecting different inputs. At FIG. 6K, computer system 600 detects selection input 605kl directed to play/pause control 626d. At FIG. 6K, computer system 600 detects selection input 605k2 directed to mop indicator 626e1. At FIG. 6K, computer system 600 detects selection input 605k3 directed to rooms region 626f.

FIG. 6L illustrates a scenario following selection input 605k1. As illustrated in FIG. 6L, in response to detecting selection input 605kl directed to play/pause control 626d, computer system 600 sends a signal to the controlled device to activate. At FIG. 6L, in response to receiving a signal from computer system 600, the controlled device activates and begins performing the selected operation (e.g., “Vacuuming” following the selection of vacuum indicator 626e2 as illustrated in FIG. 6K). As illustrated in FIG. 6L, in response to detecting selection input 605k1, status indicator 626b is displayed as “Vacuuming” to indicate that the controlled device is performing an operation (e.g., vacuuming). As illustrated in FIG. 6L, in response to detecting selection input 605k1, location indicator 626c is displayed as “Kitchen” to indicate that the controlled device is vacuuming in the kitchen.

As illustrated in FIG. 6L, computer system 600 displays play/pause control 626d with the appearance of two vertical rectangles (e.g., a pause symbol). Additionally, as illustrated in FIG. 6L, play/pause control 626d is displayed with small lines appearing to come from the bottom of the control to indicate that the controlled device is performing a vacuuming operation. In some embodiments, play/pause control 626d is displayed with a different visual element to indicate that the controlled device is performing a different operation. As illustrated in FIG. 6L, in response to detecting selection input 605k1, computer system 600 displays alert control 626h within user interface 626. In some embodiments, in response to detecting an input directed to alert control 626h, computer system 600 sends a signal to the controlled device to output a noise (e.g., by means of a speaker and/or speaker system belonging to the controlled device) to alert the user to the location of the controlled device.

FIG. 6M illustrates a scenario following selection input 605k2. As illustrated in FIG. 6L, in response to detecting selection input 605k2 directed to mop indicator 626e1, computer system 600 displays selection indicator 626e4 over mop indicator 626e1 indicating that the controlled device will perform a mopping operation upon activation. In some embodiments, in response to detecting a selection input directed to a different indicator (e.g., mop-and-vacuum indicator 626e3), computer system 600 displays selection indicator 626e4 over the different indicator indicating that the controlled device will perform a corresponding operation upon activation. At FIG. 6M, computer system 600 detects selection input 605m directed to play/pause control 626d.

FIG. 6N illustrates a scenario occurring at a time after FIG. 6M. At FIG. 6N, the controlled device makes a determination that it and/or a base station is full of debris. In response to making a determination that it and/or a base station is full of debris, the controlled device sends a signal of the status to computer system 600. As illustrated in FIG. 6N, in response to receiving a signal of the status of the controlled device, computer system 600 updates user interface 626 to include device error indicator 626i and error type indicator 626j to reflect the status of the controlled device.

In some embodiments, computer system 600 displays device error indicator 626i to indicate an error. As illustrated in FIG. 6N, device error indicator 626i is displayed as “Base Station full”, indicating that the base station of the controlled device is full of debris. In some embodiments, computer system 600 displays error type indicator 626j to indicate an error with the controlled device. As illustrated in FIG. 6N, error type indicator 626j is displayed as an exclamation mark, indicating that the base station of the controlled device is full of debris.

Additionally, as part of updating user interface 626 to reflect the status of the controlled device, as illustrated in FIG. 6N, computer system 600 displays status indicator 626b as “Returning to station” to indicate that the controlled device is returning to the base station. As illustrated in FIG. 6N, computer system 600 displays location indicator 626c as “Kitchen” to indicate that the controlled device is currently in the kitchen and/or the controlled device was performing an operation (e.g., mopping) in the kitchen as it determined that the base station is full of debris.

FIGS. 60-6W illustrate a process for changing the order of operations of the controlled device for the rooms in the home. FIG. 6O illustrates a scenario following selection input 605k3. In some embodiments, the selection of all rooms for the controlled device to perform an operation on upon activation is a default selection in response to detecting selection input 605k3. As illustrated in FIG. 6O, in response to detecting selection input 605k3, computer system 600 ceases display of user interface 626 and displays user interface 628 (e.g., a room list user interface) as overlaid on user interface 602. User interface 628 includes done control 628a, rooms region 628b, portion control 628c, caret 628c1, caret 628c2, and selected rooms list 630. In some embodiments, in response to detecting an input directed to done control 628a, computer system 600 ceases display of user interface 628 and maintains user interface 602. As also illustrated in FIG. 6O, computer system 600 maintains display of home name indicator 698 while displaying user interface 628. It should be recognized that more, fewer, and/or different elements can be included in user interface 628. For example, when all rooms are selected, selected rooms list 630 might not be displayed and only be displayed in response to the controlled device performing an operation and/or when specific rooms are selected.

In some embodiments, computer system 600 displays rooms region 628b to indicate the chosen amount of rooms in the home that the controlled device will perform an operation in. Rooms region 628b includes all rooms indicator 628b1, specific rooms indicator 628b2, and selection indicator 628b3. As illustrated in FIG. 6O, each of all rooms indicator 628b1 and specific rooms indicator 628b2 is displayed as a selectable user interface element. In some embodiments, in response to detecting an input directed to all rooms indicator 628b1, computer system 600 selects all rooms for the controlled device to perform an operation on upon activation. In some embodiments, in response to detecting an input directed to specific rooms indicator 628b2, computer system 600 selects specific rooms for the controlled device to perform an operation on upon activation. In some embodiments, selection indicator 628b3 indicates the rooms chosen for the controlled device to perform an operation in. As illustrated in FIG. 6O, selection indicator 628b3 is displayed next to all rooms indicator 628b1, indicating that the controlled device will perform an operation on all rooms in the home and/or in a selected portion of the home.

In some embodiments, in response to detecting an input directed to portion control 628c, computer system 600 displays a user interface element that can allow the user to choose which rooms are displayed as options in user interface 628 depending on the portion (e.g., level, segment and/or floor of the home) chosen. As illustrated in FIG. 6O, portion control 628c is displayed as “Main floor” to indicate that the rooms displayed within user interface 628 correspond to the main floor of the home. As illustrated in FIG. 6O, portion control 628c is displayed as a selectable user interface element. In some embodiments, in response to detecting an input directed to caret 628c1, computer system 600 changes the portion for which computer system 600 displays rooms for. Additionally, in some embodiments, in response to detecting an input directed to caret 628c1, portion control 628c is displayed as whatever name the selected portion is set to. For example, in response to detecting an input directed to caret 628c1, computer system 600 can display portion control 628c as “Upstairs” to reflect the change of the selected portion. In some embodiments, in response to detecting an input directed to caret 628c2, computer system 600 changes the portion for which computer system 600 displays rooms for. Additionally, in some embodiments, in response to detecting an input directed to caret 628c2, portion control 628c is displayed as whatever name the selected portion is set to.

In some embodiments, computer system 600 displays selected rooms list 630 to indicate which rooms in the home the controlled device will perform an operation in with the selection of either all rooms indicator 628b1 or specific rooms indicator 628b2. As illustrated in FIG. 6O, selected rooms list 630 includes minus control 632, room indicator 634 (e.g., “Kitchen”), minus control 636, room indicator 638 (e.g., “Dining room”), minus control 640, room indicator 642 (e.g., “Hallway”), minus control 644, room indicator 646 (e.g., “Guest Bathroom”), minus control 648, room indicator 650 (e.g., “Guest Bedroom”), minus control 652, and room indicator 654 (e.g., “Office”). For example, when all rooms indicator 628b1 is selected and portion control 628c is displayed as “Main floor”, all rooms corresponding to the main floor of the home can be selected for the controlled device to perform an operation in upon activation. As illustrated in FIG. 6O, each of minus control 632, minus control 636, minus control 640, minus control 644, minus control 648, and minus control 652 is displayed as a selectable user interface element.

In some embodiments, in response to detecting an input directed to a minus control (e.g., minus control 632, minus control 636, minus control 640, minus control 644, minus control 648, and/or minus control 652), computer system 600 ceases display of a corresponding one of the room indicators (e.g., room indicator 634, room indicator 638, room indicator 642, room indicator 646, room indicator 650, and/or room indicator 654) . . . . In some embodiments, computer system 600 displays a removed room indicator within a new user interface element. In some embodiments, the order of room indicators 634, 638, 642, 646, 650, and/or 654 are different. In some embodiments, different room indicators are included within selected rooms list 630.

At FIG. 6O, computer system 600 detects selection input 60501 directed to specific rooms indicator 628b2. At FIG. 6O, computer system 600 detects selection input 60502 directed to minus control 644. At FIG. 6O, computer system 600 detects selection input 60503 directed to minus control 648. At FIG. 6O, computer system 600 detects selection input 60504 directed to minus control 652.

At FIG. 6P, in response to detecting selection input 60501 and/or in response to detecting selection input 605k3, computer system 600 selects specific rooms for the controlled device to perform an operation in upon activation. In some embodiments, the selection of specific rooms for the controlled device to perform an operation in upon activation is a default selection in response to detecting selection input 605k3. Additionally, as illustrated in FIG. 6P, selection indicator 628b3 is displayed next to specific rooms indicator 628b2, indicating that the controlled device will perform an operation within specific rooms in the home (e.g., rooms listed in selected rooms list 630). As illustrated in FIG. 6P, computer system 600 displays minus control 632, room indicator 634 (e.g., “Kitchen”), minus control 636, room indicator 638 (e.g., “Dining room”), minus control 640, and room indicator 642 (e.g., “Hallway”) within selected rooms list 630. For example, computer system 600 can select the kitchen, the dining room, and the hallway as rooms for the controlled device to perform an operation in upon activation. Additionally, in response to detecting selection input 60501, more rooms list 656 is displayed to include other rooms that can be added to selected rooms list 630 (e.g., more rooms list 656 includes rooms that are not selected for the controlled device to perform an operation on upon activation).

As illustrated in FIG. 6P, in response to detecting selection input 60502, computer system 600 selects specific rooms for the controlled device to perform an operation in upon activation (e.g., as indicated by selection indicator 628b3) and/or ceases display of room indicator 646 (e.g., “Guest Bathroom”) within selected rooms list 630 and displays room indicator 646 within more rooms list 656. As illustrated in FIG. 6P, in response to detecting selection input 60503, computer system 600 selects specific rooms for the controlled device to perform an operation on upon activation (e.g., as indicated by selection indicator 628b3) and/or ceases display of room indicator 650 (e.g., “Guest Bedroom”) within selected rooms list 630 and displays room indicator 650 within more rooms list 656. As illustrated in FIG. 6P, in response to detecting selection input 60504, computer system 600 selects specific rooms for the controlled device to perform an operation in upon activation (e.g., as indicated by selection indicator 628b3) and/or ceases display of room indicator 654 (e.g., “Office”) within selected rooms list 630 and displays room indicator 654 within more rooms list 656. Additionally, more rooms list 656 includes plus control 658, plus control 660, and plus control 662. As illustrated in FIG. 6P, each of plus control 658, plus control 660, and plus control 662 is displayed as a selectable user interface element. In some embodiments, computer system 600 selects specific rooms based on an order of rooms (e.g., because the kitchen, dining room, and hallway are the first rooms in the list (e.g., as illustrated by room list 614b in FIG. 6E) for the main floor, computer system 600 selects these three rooms). In some embodiments, computer system 600 selects specific rooms based on proximity (e.g., the kitchen, dining room, and hallway are the closest to each other within the home). In some embodiments, computer system 600 selects specific rooms based on inputs (e.g., as illustrated in FIG. 6O).

In some embodiments, in response to detecting an input directed to plus control 658, computer system 600 ceases display of room indicator 646 within more rooms list 656 and displays room indicator 642 within selected rooms list 630 (e.g., computer system 600 adds the room back to the selected rooms for the controlled device to perform an operation in upon activation). In some embodiments, in response to detecting an input directed to plus control 660, computer system 600 ceases display of room indicator 650 within more rooms list 656 and displays room indicator 650 within selected rooms list 630. In some embodiments, in response to detecting an input directed to plus control 662, computer system 600 ceases display of room indicator 654 within more rooms list 656 and displays room indicator 654 within selected rooms list 630.

At FIG. 6P, computer system 600 detects selection input 605p1 directed to minus control 640. In some embodiments, selection input 605p1 is a tap input on minus control 640. At FIG. 6P, computer system 600 detects selection input 605p2 directed to plus control 658. In some embodiments, selection input 605p2 is a tap input on plus control 658.

As illustrated in FIG. 6Q, in response to detecting selection input 605p1, computer system 600 ceases display of room indicator 642 (e.g., “Hallway”) within selected rooms list 630 and displays room indicator 642 within more rooms list 656 (e.g., computer system 600 removes the hallway from the list of rooms for the controlled device to perform an operation on). As illustrated in FIG. 6Q, in response to detecting selection input 605p2, computer system 600 ceases display of room indicator 646 (e.g., “Guest Bathroom”) within more rooms list 656 and displays room indicator 646 within selected rooms list 630 (e.g., computer system 600 adds the Guest Bathroom to the list of rooms for the controlled device to perform an operation on). At FIG. 6Q, computer system 600 detects selection input 605q directed to portion control 628c. In some embodiments, selection input 605q is a tap input on portion control 628c.

As illustrated in FIG. 6R, in response to detecting selection input 605q, computer system 600 displays portion list 664. Portion list 664 includes main floor control 664a, upstairs control 664b, and selection indicator 664c. As illustrated in FIG. 6R, each of main floor control 664a and upstairs control 664b is displayed as a selectable user interface element. In some embodiments, in response to detecting an input directed to main floor control 664a, computer system 600 displays rooms corresponding to the main floor of the home as options to be selected for the controlled device to perform an operation in (e.g., within selected rooms list 630 and/or more rooms list 656). In some embodiments, in response to detecting an input directed to upstairs control 664b, computer system 600 displays rooms corresponding to the upstairs floor of the home as options to be selected for the controlled device to perform an operation on (e.g., within selected rooms list 630 and/or more rooms list 656). In some embodiments, selection indicator 664c indicates the portion chosen for computer system 600 to display room selections and/or options for. At FIG. 6R, computer system 600 detects selection input 605r directed to upstairs control 664b. In some embodiments, selection input 605r is a tap input on upstairs control 664b.

As illustrated in FIG. 6S, in response to detecting selection input 605r, computer system 600 displays rooms corresponding to the upstairs level of the home (e.g., as discussed above in FIG. 6E) within user interface 628. For example, computer system 600 ceases display of room indicator 634 (e.g., “Kitchen”), room indicator 638 (e.g., “Dining room”), and room indicator 646 (e.g., “Guest Bathroom”) within selected rooms list 630 and displays room indicator 666 (e.g., “Master Bedroom”) and room indicator 668 (e.g., “Master Bathroom”) within selected rooms list 630 (e.g., rooms corresponding to the upstairs level of the home).

Additionally, computer system 600 ceases display of room indicator 650 (e.g., “Guest Bedroom”), room indicator 654 (e.g., “Office”), and room indicator 642 (e.g., “Hallway”) within selected rooms list 630 and displays room indicator 670 (e.g., “Caleb's Bedroom”) and room indicator 672 (e.g., “Caleb's Bathroom”) within more rooms list 656 (e.g., rooms corresponding to the upstairs level of the home). As illustrated in FIG. 6S, in response to detecting selection input 605r, portion control 628c is displayed as “Upstairs” to indicate that the rooms displayed within user interface 628 correspond to the upstairs floor of the home.

FIGS. 6T-6U illustrate a separate embodiment that occurs while the controlled device is active (e.g., is performing an operation and/or is running). As illustrated in FIG. 6T, user interface 628 includes rooms corresponding to the main floor of the home as indicated by portion control 628c. Additionally, the controlled device is set to perform an operation in specific rooms in the home, as indicated by selection indicator 628b3. As illustrated in FIG. 6T, selected rooms list 630 includes status indicator 674, order control 676, and order control 678. As illustrated in FIG. 6T, each of order control 676 and order control 678 is displayed as a selectable user interface element. It should be recognized that such order controls can also be displayed, in some embodiments, while the controlled device is inactive, such as with respect to FIGS. 60-6S.

In some embodiments, status indicator 674 indicates the operation that the controlled device is performing. As illustrated in FIG. 6T, status indicator 674 is displayed as “Vacuuming” and is next to room indicator 634, indicating that the controlled device is performing a vacuuming operation in the kitchen. In some embodiments, status indicator 674 is displayed differently depending on the operation being performed (e.g., vacuuming, mopping, and/or vacuuming and mopping).

In some embodiments, in response to detecting an input directed to order control 676, computer system 600 changes the order of the rooms within selected rooms list 630. In some embodiments, computer system 600 displays order control 676 next to a room indicator to indicate that the controlled device has not started an operation in the corresponding room. As illustrated in FIG. 6T, order control 676 is displayed next to room indicator 638 (e.g., “Dining room”), indicating that the controlled device has not started an operation in the dining room. In some embodiments, the input is a press and drag input. In some embodiments, the input is a swipe input. In some embodiments, the input is a voice command. As an example, in a scenario where a downward press and drag input is directed to order control 676, in response to detecting the input, computer system 600 changes the order of room indicator 638 and room indicator 646 (e.g., computer system 600 moves the dining room further down the list to be operated in by the controlled device at a later time). Similarly, such an input can be applied to another one of the order controls to change an order within the selected rooms list 630. In some embodiments, in response to detecting an input directed to order control 678, computer system 600 changes the order of the rooms within selected rooms list 630. In some embodiments, computer system 600 displays order control 678 next to a room indicator to indicate that the controlled device has not started an operation in the corresponding room. At FIG. 6T, computer system 600 detects upward press and drag input 605t directed to order control 678.

As illustrated in 6U, in response to detecting upward press and drag input 605t, computer system 600 changes the order of room indicator 638 and room indicator 646 to place the guest bathroom ahead of the dining room in the order of operations for the controlled device. As illustrated in FIG. 6U, status indicator 674 is displayed as “Complete”, indicating that the controlled device has finished performing an operation in the kitchen. Additionally, computer system 600 ceases display of minus control 632 (e.g., because the controlled device already performed an operation in the kitchen, computer system 600 removes minus control 632). In some embodiments, rather than “Complete”, computer system 600 displays another operation if more than one operation is set for a room. For example, after completing a vacuuming operation in the kitchen, computer system 600 can display “Mopping” if the controlled device is set to perform a mopping operation in the kitchen.

Additionally, computer system 600 ceases display of order control 678 and displays status indicator 680 next to room indicator 646. In some embodiments, computer system 600 maintains display of minus control 636 next to room indicator 646 while an operation is being performed with respect to the corresponding room. In some embodiments, computer system 600 ceases display of minus control 636 next to room indicator 646 while an operation is being performed with respect to the corresponding room. In some embodiments, status indicator 680 indicates the operation that the controlled device is performing. As illustrated in FIG. 6U, status indicator 674 is displayed as “Mopping”, indicating that the controlled device is performing a mopping operation in the guest bathroom. As illustrated in FIG. 6U, computer system 600 displays order control 676 next to room indicator 638, indicating that the controlled device has not started an operation on the dining room. It should be recognized that, without detecting press and drag input 605t, the order of room operations would not change and the controlled device would be performing an operation on the dining room rather than the guest bathroom.

Although not shown, it should be recognized that upon the controlled device completing the mopping operation in the guest bathroom, computer system 600 displays status indicator 680 as “Complete” (e.g., upon completion of an operation in a room, computer system 600 displays a status indicator as “Complete”).

FIGS. 6V-6W illustrate a separate embodiment that occurs while the controlled device is active (e.g., is performing an operation and/or is running). As illustrated in FIG. 6V, computer system 600 displays status indicator 674 as “vacuuming” next to room indicator 634 to indicate that the controlled device is performing a vacuuming operation in the kitchen. Additionally, order control 676 and order control 678 are displayed next to room indicator 646 and room indicator 642 respectively, indicating that the controlled device has not yet started performing an operation on the dining room or the hallway. At FIG. 6V, computer system 600 detects selection input 605v directed to minus control 640. In some embodiments, selection input 605v is a tap input on minus control 640.

As illustrated in FIG. 6W, in response to detecting selection input 605v, computer system 600 ceases display of room indicator 642 within selected rooms list 630 (e.g., computer system 600 removes the hallway from the order of operations) and displays room indicator 642 within more rooms list 656. In some embodiments, room indicator 642 is able to be removed from selected rooms list 630 because the controlled device has not yet started an operation in the hallway. Additionally, computer system 600 displays plus control 682 next to room indicator 642 within more rooms list 656. It should be understood that any one or more of the changes described with respect to FIGS. 60-6U can be performed with respect to the embodiment of FIGS. 6V-6W.

FIG. 7 is a flow diagram illustrating a process (e.g., process 700) for updating a room list for while a device performs one or more operations in accordance with some embodiments. Some operations in process 700 are, optionally, combined, the orders of some operations are, optionally, changed, and some operations are, optionally, omitted.

As described below, process 700 provides an intuitive way for updating a room list for while a device performs one or more operations. Process 700 reduces the cognitive burden on a user, thereby creating a more efficient human-machine interface. For battery-operated computing devices, enabling a user to interact with such devices faster and more efficiently conserves power and increases the time between battery charges.

In some embodiments, process 700 is performed at a computer system (e.g., 600) that is in communication (e.g., wired communication and/or wireless communication) with one or more display generation components (e.g., a display screen, a projector, a head mounted display, and/or a touch-sensitive display) and one or more input devices (e.g., a camera, a depth sensor, a microphone, a hardware input mechanism, a rotatable input mechanism, a physical input mechanism, a button, a crown, a knob, a dial, a physical slider, an accelerometer, a mouse, a keyboard, a touchpad, and/or a touch-sensitive surface). In some embodiments, the computer system is a watch, a phone, a tablet, a fitness tracking device, a processor, a head-mounted display (HMD) device, a communal device, a media device, a speaker, a television, an electronic device, and/or a personal computing device.

While (e.g., after and/or in response to) displaying, via the one or more display generation components, a room list (e.g., 630) (e.g., list of rooms, zones, regions, areas, and/or spaces) including an indication (e.g., 674 and/or 680) (e.g., status, text, graphic, icon, and/or animation) that a device (e.g., mobile device, robot device, cleaning device, vacuum device, mopping device, controlled device, remote controlled device, external device, and/or robot vacuum) is currently performing a respective operation (e.g., cleaning, vacuuming, mopping, and/or traversing) in a first room (and/or a first location) (e.g., of and/or in the room list) (and/or while the device is currently performing a process to perform one or more operations with respect to each room in the room list), the computer system detects (702), via the one or more input devices, an input (e.g., 605o2, 605o3, 605o4, 605p1, 605p2, 605t, and/or 605v) (e.g., a selection input, a non-selection input, a movement input, and/or a non-movement input) corresponding to (e.g., directed to, at a location of, related to, and/or associated with) a request to modify (e.g., change, alter, update, and/or reorder) the room list. In some embodiments, the indication that the device is currently performing a respective operation includes a description and/or identification of the respective operation (e.g., cleaning, vacuuming, moping, and/or traversing). In some embodiments, the indication that the device is currently performing the respective operation is displayed at a location corresponding to (e.g., at a location of, adjacent to, and/or near) an indication of the first room. In some embodiments, the room list includes a selectable user interface element for removing a respective room from the room list (e.g., and/or adding the respective room to the room list). In some embodiments, the room list (e.g., first room list) includes or is displayed with a list of additional rooms (e.g., a second room list) for which the device has not performed, is not performing, and/or is not to perform a respective operation.

In response to (704) detecting the input corresponding to the request to modify the room list, in accordance with a determination that a first set of one or more criteria is satisfied, the computer system updates (706) (e.g., changes, modifies, and/or alters) the room list (e.g., based on the input corresponding to the request to modify the room list) in a first manner (e.g., at FIGS. 6P, 6U, 6V, and/or 6W) (e.g., displays the room list with a first modification).

In response to (704) detecting the input corresponding to the request to modify the room list, in accordance with a determination that a second set of one or more criteria, different from the first set of one or more criteria, is satisfied, the computer system updates (708) (e.g., changes, modifies, and/or alters) the room list (e.g., based on the input corresponding to the request to modify the room list) in a second manner (e.g., at FIGS. 6P, 6U, 6V, and/or 6W) (e.g., displays the room list with a second modification) different from the first manner. In some embodiments, the first set of one or more criteria includes a criterion that is satisfied when the input satisfies a criterion. In some embodiments, updating the room list in the first manner and/or the second manner includes adding a room to the room list. In some embodiments, the computer system adds the room to the room list simultaneous with removing the room from another room list. In some embodiments, the computer system adds the room to the room list when the input satisfies a first criterion. In some embodiments, updating the room list in the first manner and/or the second manner includes removing a room from the room list. In some embodiments, the computer system removes the room from the room list simultaneous with adding the room to another room list. In some embodiments, the computer system removes the room from the room list when the input satisfies a second criterion different from the first criterion. In some embodiments, updating the room list in the first manner and/or the second manner includes changing an order of the rooms in the room list. In some embodiments, the computer system changes the order of the rooms in the room list when the input satisfies a third criterion different from the first criterion and/or the second criterion. Updating a room list in one of multiple manners while displaying an indication that a device is currently performing a respective operation allows the computer system to provide the user with an ability to update the room list while operations are being performed, thereby performing an operation when a set of conditions has been met without requiring further user input, reducing the number of inputs needed to perform an operation, providing additional control options without cluttering the user interface with additional displayed controls, and/or providing improved visual feedback to the user.

In some embodiments, in accordance with a determination that the device has completed a respective operation (e.g., cleaning, vacuuming, mopping, and/or traversing) in a second room (and/or a second location) (e.g., of and/or in the room list) (and/or after the device has completed and/or ceased performing a process to perform one or more operations with respect to one or more rooms in the room list) different from the first room, the room list includes an indication (e.g., 674 in FIG. 6U) (e.g., text, graphic, label, icon, color, emphasis, highlighting, and/or animation) that the device has completed the respective operation in the second room (e.g., at least one operation corresponding to the second room is complete, all operations corresponding to the second room are complete, and/or an operation for a subsequent room in the room list have been started). In some embodiments, the room list includes an identification of the second room (e.g., in which the device has performed and/or has completed performance of the respective operation). In some embodiments, the indication that the device has completed the respective operation in the second room indicates that the respective operation in the second room is complete. In some embodiments, the indication that the device has completed the respective operation in the second room is provided separate from an identification of the second room. In some embodiments, the indication that the device has completed the respective operation in the second room is provided separate from one or more selectable user interface elements associated with the second room. In some embodiments, the second room is in the room list while the indication that the device has completed the respective operation in the second room is displayed. In some embodiments, one or more other rooms in the room list (e.g., not including the second room) is displayed with a corresponding selectable user interface element. In some embodiments, the second room is displayed without a corresponding selectable user interface element in accordance with a determination that the device has completed the respective operation in the second room. In some embodiments, the indication that the device has completed the respective operation in the second room is displayed concurrently with the indication that the device is currently performing the respective operation in the first room. In some embodiments, the indication that the device has completed the respective operation in the second room is displayed separate from the indication that the device is currently performing the respective operation in the first room. In some embodiments, the room list includes one or more additional rooms before and/or after (e.g., above and/or below) the first room and/or the second room. Displaying an indication of a room in which a device has completed a respective operation allows the computer system to provide a user with information relating to operation of the device with respect to the room, thereby performing an operation when a set of conditions has been met without requiring further user input, reducing the number of inputs needed to perform an operation, and/or providing improved visual feedback to the user.

In some embodiments, in accordance with a determination that the device has not yet started a respective operation (e.g., cleaning, vacuuming, mopping, and/or traversing) in a third room (and/or a third location) (e.g., of and/or in the room list) (and/or before the device has started performing a process to perform one or more operations with respect to one or more rooms in the room list) different from the first room (and/or the second room), the room list includes an indication (e.g., 676 and/or 678) (e.g., text, graphic, label, icon, color, emphasis, highlighting, and/or animation) that the device has not yet started the respective operation in the third room (e.g., at least one operation corresponding to the third room has not yet been started, none of the operations corresponding to the third room have been started, and/or an operation for a preceding room in the room list has not yet been completed). In some embodiments, the room list includes an identification of the third room (e.g., in which the device not yet started the respective operation). In some embodiments, the indication that the device has not yet started the respective operation in the third room indicates that the respective operation in the third room is not yet started. In some embodiments, the indication that the device has not yet started the respective operation in the third room is provided separate from an identification of the third room. In some embodiments, the indication that the device has not yet started the respective operation in the third room is provided separate from one or more selectable user interface elements associated with the third room. In some embodiments, the third room is in the room list while the indication that the device has not yet started the respective operation in the third room is displayed. In some embodiments, one or more other rooms in the room list (e.g., not including the third room) is displayed without a corresponding selectable user interface element. In some embodiments, the third room is displayed with a corresponding selectable user interface element. In some embodiments, the indication that the device has not yet started the respective operation in the third room is displayed concurrently with the indication that the device is currently performing the respective operation in the first room. In some embodiments, the indication that the device has not yet started the respective operation in the third room is displayed separate from the indication that the device is currently performing the respective operation in the first room. In some embodiments, the indication that the device has not yet started the respective operation in the third room is displayed concurrently with the indication that the device has completed the respective operation in the second room. In some embodiments, the indication that the device has not yet started the respective operation in the third room is displayed separate from the indication that the device has completed the respective operation in the second room. In some embodiments, the room list includes one or more additional rooms before and/or after (e.g., above and/or below) the first room, the second room, and/or the third room. Displaying an indication of a room in which a respective operation has not yet started allows the computer system to provide a user with information relating to operation of a device with respect to the room, thereby performing an operation when a set of conditions has been met without requiring further user input, reducing the number of inputs needed to perform an operation, and/or providing improved visual feedback to the user.

In some embodiments, in accordance with a determination that the respective operation is a first operation (e.g., cleaning, vacuuming, mopping, and/or traversing) (and/or a first type of operation), the indication that the device is currently performing the respective operation includes first content (e.g., 624b, 626b, 626d, 674, and/or 680). In some embodiments, the first content includes an identification of the first operation. In some embodiments, in accordance with a determination that the respective operation is a second operation (e.g., cleaning, vacuuming, mopping, and/or traversing) (and/or a second type of operation different from the first type of operation) different from the first operation, the indication that the device is currently performing the respective operation includes second content (e.g., 624b, 626b, 626d, 674, and/or 680) (e.g., without including the first content) different from the first content. In some embodiments, the second content includes an identification of the second operation. In some embodiments, the first content and/or the second content includes an indication (e.g., description) of the respective operation. In some embodiments, the first content and/or the second content is separate from the room list. In some embodiments, the first indication and/or the second indication is provided separate from an identification of the fourth room. In some embodiments, the first indication and/or the second indication is provided separate from one or more selectable user interface elements associated with the respective operation. In some embodiments, the computer system detects, via the one or more input devices, an input (e.g., a selection input and/or a non-selection input) corresponding to a selectable user interface element, of the one or more selectable user interface elements, to change (e.g., start, stop, and/or pause) the respective operation. In some embodiments, the input corresponding to the selectable user interface element is a tap on the selectable user interface element. In some embodiments, the first content is not displayed concurrently with the second content. In some embodiments, in accordance with a determination that the respective operation is not the first operation, the computer system ceases and/or forgoes displaying the first content. In some embodiments, in accordance with a determination that the respective operation is not the second operation, the computer system ceases and/or forgoes displaying the second content. Outputting first content when a respective operation performed by a device is a first operation and second content when the respective operation performed by the device is a second operation allows the computer system to provide to the user content regarding the respective operation performed by the device, thereby performing an operation when a set of conditions has been met without requiring further user input, reducing the number of inputs needed to perform an operation, and/or providing improved visual feedback to the user.

In some embodiments, the indication that the device is currently performing the respective operation in the first room is a first indication (e.g., 674 and/or 680). In some embodiments, the respective operation is a first respective operation. In some embodiments, after the first respective operation is (and/or in response to the first respective operation being) performed and in accordance with a determination that the device is performing a second respective operation (e.g., cleaning, vacuuming, mopping, and/or traversing) separate (and/or different) from the first respective operation, the computer system displays, via the one or more display generation components, a second indication (e.g., 674 and/or 680) (e.g., text, graphic, label, icon, color, emphasis, highlighting, and/or animation) that the device is currently performing the second respective operation, wherein the second indication is separate (and/or different) from the first indication. In some embodiments, after the first respective operation is (and/or in response to the first respective operation being) performed and in accordance with a determination that the device is not performing the first respective operation, the computer system ceases and/or forgoes display of the first indication. In some embodiments, after the first respective operation is (and/or in response to the first respective operation being) performed and in accordance with the determination that the device is performing the second respective operation, the computer system ceases and/or forgoes display of the first indication. In some embodiments, after the first respective operation is (and/or in response to the first respective operation being) performed and in accordance with the determination that the device is not performing the second respective operation, the computer system ceases and/or forgoes display of the second indication. In some embodiments, the second indication is displayed without the first indication. In some embodiments, after the first respective operation is (and/or in response to the first respective operation being) performed and in accordance with a determination that the device has ceased (e.g., stopped, paused, interrupted, and/or is unable to complete) the first respective operation in the first room, the computer system ceases display of the first indication. In some embodiments, the second indication is a description of the second respective operation. In some embodiments, the first indication and/or the second indication is separate from the room list. In some embodiments, the first indication and/or the second indication is included in (e.g., with and/or within) the room list. Displaying another indication when a device is performing another operation allows the computer system to provide updated information regarding a change in operation of the device, thereby performing an operation when a set of conditions has been met without requiring further user input, reducing the number of inputs needed to perform an operation, and/or providing improved visual feedback to the user.

In some embodiments, the second indication corresponds to the first room (e.g., at FIGS. 6T, 6V, and 6W) (e.g., the second indication that the device is currently performing the second respective operation is an indication that the device is currently performing the second respective operation in the first room). In some embodiments, the second indication is displayed in a manner (e.g., at a location and/or having a visual characteristic) associated with (e.g., near, adjacent to, aligned with, and/or sharing a visual characteristic in common with) the first room. In some embodiments, after the first respective operation is (and/or in response to the first respective operation being) performed and in accordance with a determination that the device is not performing the second respective operation in the first room (e.g., performing a different operation and/or in a different room), the computer system ceases and/or forgoes display of the second indication. In some embodiments, the second indication is provided separate from an identification of the first room. In some embodiments, the second indication is a description of the second respective operation. In some embodiments, the second indication does not correspond to another room different from the first room. Displaying different indications when different operations are being performed in the same room allows the computer system to provide information relating to operation of a device with respect to the same room, thereby performing an operation when a set of conditions has been met without requiring further user input, reducing the number of inputs needed to perform an operation, and/or providing improved visual feedback to the user.

In some embodiments, second indication corresponds to a fourth room different from the first room (e.g., at FIG. 6U) (e.g., the second indication that the device is currently performing the second respective operation is an indication that the device is currently performing the second respective operation in the fourth room). In some embodiments, the second indication is displayed in a manner (e.g., at a location and/or having a visual characteristic) associated with (e.g., near, adjacent to, aligned with, and/or sharing a visual characteristic in common with) the fourth room. In some embodiments, after the first respective operation is (and/or in response to the first respective operation being) performed and in accordance with a determination that the device is not performing the second respective operation in the fourth room (e.g., performing a different operation and/or in a different room), the computer system ceases and/or forgoes display of the second indication. In some embodiments, the room list includes an identification of the fourth room. In some embodiments, the second indication is provided separate from an identification of the fourth room. In some embodiments, the second indication is a description of the second respective operation. In some embodiments, the second indication does not correspond to another room different from the fourth room. Displaying different indications when different operations are being performed in different rooms allows the computer system to provide information relating to operation of a device with respect to different rooms, thereby performing an operation when a set of conditions has been met without requiring further user input, reducing the number of inputs needed to perform an operation, and/or providing improved visual feedback to the user.

In some embodiments, the first indication has a first appearance (e.g., a visual appearance). In some embodiments, the second indication has the first appearance (e.g., at FIG. 6U) (e.g., has the same text, color, and/or shape). In some embodiments, the first indication is displayed at a first position. In some embodiments, the second indication is displayed at a second position different from the first position. In some embodiments, the first operation is displayed in a manner (e.g., at a location and/or having a visual characteristic) associated with (e.g., near, adjacent to, aligned with, and/or sharing a visual characteristic in common with) the first room. In some embodiments, the second indication is displayed in a manner (e.g., at a location and/or having a visual characteristic) associated with (e.g., near, adjacent to, aligned with, and/or sharing a visual characteristic in common with) the fourth room (and/or another room different from the first room). In some embodiments, multiple indications are displayed for one or more rooms in the room list. In some embodiments, the first indication is displayed concurrently with the second indication. In some embodiments, multiple indications that the device is currently performing an operation (e.g., displayed simultaneously or separately) are displayed with one or more visual characteristics in common. In some embodiments, the second indication has the same appearance as the first indication even when the second respective operation is different from the first respective operation. Displaying separate indications with the same appearance for performing operations in different rooms allows the computer system to provide information for different rooms in a manner that is understandable by the user, thereby performing an operation when a set of conditions has been met without requiring further user input, reducing the number of inputs needed to perform an operation, and/or providing improved visual feedback to the user.

In some embodiments, updating the room list in the first manner includes removing a fifth room (e.g., a selected room and/or a room that corresponds to the input corresponding to the request to modify the room list) from the room list (e.g., at FIGS. 6Q and 6W). In some embodiments, the fifth room is the first room. In some embodiments, the fifth room is another room different from the first room. In some embodiments, one or more other rooms in the room list (e.g., not including the fifth room) is not removed and/or is maintained in the room list in response to (and/or after) updating the room list in the first manner. In some embodiments, removing the fifth room from the room list includes removing the fifth room from a user interface including the room list. In some embodiments, removing the fifth room from the room list includes moving the fifth room from the room list to another room list (e.g., a list of one or more rooms that are not selected for the device to perform one or more operations) different from the room list. In some embodiments, updating the room list in the first manner includes maintaining the fifth room in the room list while displaying an indication that the device is not to perform an (e.g., any) operation in the fifth room. In some embodiments, the first set of one or more criteria includes a criterion that is satisfied when the input corresponds to the fifth room. Updating a room list by removing a room from the room list allows the computer system to provide a user with an ability to remove the room from the room list with an input, thereby performing an operation when a set of conditions has been met without requiring further user input, reducing the number of inputs needed to perform an operation, providing additional control options without cluttering the user interface with additional displayed controls, and/or providing improved visual feedback to the user.

In some embodiments, while detecting the input corresponding to the request to modify the room list, the room list includes an indication (e.g., 674) (e.g., text, graphic, label, icon, color, emphasis, highlighting, and/or animation) that the device has completed an operation (e.g., cleaning, vacuuming, mopping, and/or traversing) in the fifth room (e.g., at least one operation corresponding to the fifth room is complete, all operations corresponding to the selected room are complete, and/or an operation for a subsequent room in the room list has been started). In some embodiments, the room list includes an identification of the fifth room. In some embodiments, the indication that the device has completed the operation in the fifth room indicates that the operation in the fifth room is complete. In some embodiments, the indication that the device has completed the operation in the fifth room is provided separate from an identification of the fifth room. In some embodiments, the indication that the device has completed the operation in the fifth room is provided separate from one or more selectable user interface elements for a user to select the fifth room. In some embodiments, the indication that the device has completed the operation in the fifth room is displayed concurrently with the indication that the device is currently performing the respective operation in the first room. In some embodiments, only rooms that the device has already performed an operation are able to be removed from the room list while the device is performing a process for one or more operations. A room list including an indication that a device has completed an operation in a room while detecting an input to remove the room from the room list allows the computer system to provide to the user an ability to remove rooms that the device has already completed an operation (and/or that the device will not perform another operation until the device starts a process for performing one or more operations over again), thereby reducing the number of inputs needed to perform an operation, providing additional control options without cluttering the user interface with additional displayed controls, and/or providing improved visual feedback to the user.

In some embodiments, while detecting the input corresponding to the request to modify the room list, the room list (e.g., before, during, and/or after removing the selected room from the room list) includes an indication (e.g., 676 and/or 678) (e.g., text, graphic, label, icon, color, emphasis, highlighting, and/or animation) that the device has not yet performed (e.g., started and/or completed) an operation in the fifth room (e.g., at least one operation corresponding to the fifth room has not yet been started, none of the operations corresponding to the fifth room have been started, and/or an operation for a preceding room in the fifth room list has not yet been completed). In some embodiments, the indication that the device has not yet performed an operation in the fifth room indicates that one or more operations in the fifth room has not yet started. In some embodiments, the indication that the device has not yet performed an operation in the fifth room is provided separate from an identification of the fifth room. In some embodiments, the indication that the device has not yet performed an operation in the fifth room is provided separate from one or more selectable user interface elements for the user to select the fifth room. In some embodiments, the indication that the device has not yet performed an operation in the fifth room is in addition to the indication that the device is currently performing the respective operation in the first room. In some embodiments, the indication that the device has not yet performed an operation in the fifth room is an empty space and/or a lack of a user interface element in a location where an indication that the device is currently performing or has already performed an operation in the fifth room. In some embodiments, only rooms that the device has not yet performed an operation are able to be removed from the room list while the device is performing a process for one or more operations. A room list including an indication that a device has not yet started an operation in a room while detecting an input to remove the room from the room list allows the computer system to provide to the user an ability to remove rooms that the device has not performed an operation (and/or that the device will perform an operation in a current process for performing one or more operations), thereby reducing the number of inputs needed to perform an operation, providing additional control options without cluttering the user interface with additional displayed controls, and/or providing improved visual feedback to the user.

In some embodiments, the room list is a first room list (e.g., 630). In some embodiments, updating (e.g., at FIGS. 6Q and 6W) the first room list in the first manner includes adding the fifth room to a second room list (e.g., 656) (e.g., list of second rooms, zones, regions, areas, and/or spaces) different (and/or separate) from the first room list. In some embodiments, while displaying the first room list including a first set of one or more rooms, the computer system displays the second room list including a second set of one or more rooms different from the first set of one or more rooms. In some embodiments, the second set of one or more rooms is one or more rooms (and/or the second room list is a list of one or more rooms) for which an operation is available to be performed by the device. In some embodiments, the second set of one or more rooms is one or more rooms (and/or the second room list is a list of one or more rooms) for which an (e.g., any) operation is not to be performed (e.g., unless and/or until a room is added to and/or maintained on the first room list). In some embodiments, no room is on both the first room list and the second room list. In some embodiments, a room in the first room list can be moved to the second room list. In some embodiments, after adding the fifth room to the second room list, the second room list includes (1) an indication of the fifth rom and (2) a selectable user interface element for adding the fifth room from the second room list to the first room list. Adding a room to a second room list when removing the room from a first room list allows the computer system to provide a confirmation to the user that a device will not perform an operation in the room, thereby performing an operation when a set of conditions has been met without requiring further user input, reducing the number of inputs needed to perform an operation, and/or providing improved visual feedback to the user.

In some embodiments, while detecting the input corresponding to the request to modify the room list, the room list includes a first selectable user interface element (e.g., 632, 636, 640, 644, 648, and/or 652) (e.g., a virtual button, an icon, and/or a control) associated with (e.g., near, adjacent to, aligned with, and/or sharing a visual characteristic in common with) the fifth room. In some embodiments, the first selectable user interface element is for removing the fifth room (e.g., and not another room different from the fifth room) from the room list. In some embodiments, the room list includes one or more rooms different than the first room and the fifth room. In some embodiments, the room list includes one or more selectable user interface elements different from the first selectable user interface element. In some embodiments, the room list includes one or more selectable user interface elements, each corresponding to a respective room in the room list. In some embodiments, the room list includes one or more selectable user interface elements, each corresponding to a respective room in the room list for which an operation (e.g., any operation and/or all operations) in the respective room has not been completed. In some embodiments, the room list does not include a (e.g., any) selectable user interface element corresponding to a room for which an operation (e.g., any operation and/or all operations) in the respective room has been completed. In some embodiments, the first set of one or more criteria includes a first criterion that is satisfied when the input corresponds to (e.g., is located at) the first selectable user interface element. In some embodiments, the input corresponding to the request to modify the room list includes a selection of the first selectable user interface element. The input corresponding to the request to modify the room list includes a tap input on the first selectable user interface element. Displaying a selectable user interface element associated with a room allows the computer system to provide a way for the user to provide input to remove the room from a room list, thereby performing an operation when a set of conditions has been met without requiring further user input, reducing the number of inputs needed to perform an operation, providing additional control options without cluttering the user interface with additional displayed controls, and/or providing improved visual feedback to the user.

In some embodiments, updating the room list in the second manner includes adding (e.g., at FIG. 6Q) a sixth room (e.g., a selected room and/or a room that corresponds to the input corresponding to the request to modify the room list) to the room list. In some embodiments, the sixth room is different from the first room. In some embodiments, the sixth room is a room not currently in the room list. In some embodiments, one or more other rooms (e.g., the first room) in the room list are maintained in the room list while (e.g., and/or after) the sixth room is added to the room list. In some embodiments, adding the sixth room to the room list includes adding the sixth room to a user interface including the room list. In some embodiments, adding the sixth room to the room list includes moving the sixth room within the user interface. In some embodiments, updating the room list in the second manner includes maintaining the sixth room in the room list while displaying an indication that the device is to perform an (e.g., any) operation in the sixth room (e.g., while detecting the input corresponding to the request to modify the room list, the room list included an indication that the device is not to perform an (e.g., any) operation in the sixth room). In some embodiments, the second set of one or more criteria includes a criterion that is satisfied when the input corresponds to the sixth room. In some embodiments, detecting the input corresponding to the request to modify the room list includes detecting a request to add one or more rooms (e.g., the sixth room and, in some embodiments, another room different from the sixth room) to the room list. In some embodiments, detecting the request to add one or more rooms to the room list includes detecting an input corresponding to (e.g., directed to, at a location of, related to, and/or associated with) a selectable user interface element (e.g., text, graphic, symbol, and/or icon) corresponding to (e.g., at a location of, adjacent to, and/or near) the sixth room (e.g., a room that is not in the room list) (e.g., a selectable user interface element to add the sixth room to the room list). In some embodiments, a selectable user interface element to add a room to the room list is different from a selectable user interface element to remove a room from the room list. Updating a room list by adding a room to the room list allows the computer system to provide a user with an ability to add the room to the room list with an input, thereby performing an operation when a set of conditions has been met without requiring further user input, reducing the number of inputs needed to perform an operation, providing additional control options without cluttering the user interface with additional displayed controls, and/or providing improved visual feedback to the user.

In some embodiments, the room list is a first room list (e.g., 630) (e.g., list of first rooms, zones, regions, areas, and/or spaces). In some embodiments, updating the room list in the second manner includes removing (e.g., at FIG. 6Q) the sixth room from a second room list (e.g., 656) (e.g., list of second rooms, zones, regions, areas, and/or spaces) different (and/or separate) from the first room list. In some embodiments, while displaying the first room list including a first set of one or more rooms, the computer system displays the second room list including a second set of one or more rooms different from the first set of one or more rooms. In some embodiments, the second room list is a list of one or more rooms for which the device has not performed, is not performing, and/or is not to perform one or more operations. In some embodiments, the second set of one or more rooms is one or more rooms for which an operation is available to be performed by the device. In some embodiments, the second room list is a list of one or more rooms for which an (e.g., any) operation is not to be performed (e.g., unless and/or until a room is added to and/or maintained on the first room list). In some embodiments, no room is on both the first room list and the second room list. In some embodiments, a room in the second room list can be moved to the first room list. In some embodiments, after removing the sixth room from the second room list, the first room list includes (1) an indication of the sixth room and (2) a selectable user interface element for adding the sixth room from the first room list to the second room list. In some embodiments, after removing the sixth room from the second room list, the second room list includes (1) an indication of another room different from the sixth room and (2) a selectable user interface element for adding the other room from the second room list to the first room list. Removing a room from a second room list when adding the room to a first room list allows the computer system to provide a confirmation to the user that a device will perform an operation in the room, thereby performing an operation when a set of conditions has been met without requiring further user input, reducing the number of inputs needed to perform an operation, and/or providing improved visual feedback to the user.

In some embodiments, the room list includes a seventh room and an eighth room different from the seventh room. In some embodiments, the room list includes an indication (e.g., 676 and/or 678) that the device has not yet performed one or more (and/or any) operations in the seventh room. In some embodiments, the room list includes an indication (e.g., 676 and/or 678) that the device has not yet performed one or more (and/or any) operations in the eighth room. In some embodiments, in response to detecting the input corresponding to the request to modify the room list and in accordance with a determination that a third set of one or more criteria is satisfied, the computer system changes (e.g., at FIG. 6U) (e.g., updates, modifies, and/or alters) an order, in the room list, of the seventh room with respect to the eighth room (e.g., based on the input corresponding to the request to modify the room list). In some embodiments, in response to detecting the input corresponding to the request to modify the room list and in accordance with a determination that the third set of one or more criteria is not satisfied, the computer system forgoes change of the order, in the room list, of the seventh room with respect to the eighth room. In some embodiments, detecting the input corresponding to the request to modify the room list includes detecting a request to change the order of rooms in the room list. In some embodiments, detecting the request to change the order of the rooms in the room list includes detecting an input corresponding to (e.g., directed to, at a location of, related to, and/or associated with) a selectable user interface element. In some embodiments, detecting the request to change the order of the rooms in the room list includes detecting an input corresponding to (e.g., at a location of, adjacent to, and/or near) the seventh room and/or the eighth room. In some embodiments, the input corresponding to the request to modify the room list includes a hold-and-drag input corresponding to the seventh room or the eighth room. In some embodiments, changing the order includes moving one of the seventh room and the eighth room to be before and/or after (e.g., above and/or below) the other of the seventh room and the eighth room. Changing an order of rooms in a room list allows the computer system to provide a user with an ability to change the order of operations performed by a device, thereby performing an operation when a set of conditions has been met without requiring further user input, reducing the number of inputs needed to perform an operation, providing additional control options without cluttering the user interface with additional displayed controls, and/or providing improved visual feedback to the user.

In some embodiments, while displaying the room list, the computer system displays, via the one or more display generation components, an identifier (e.g., 698) (e.g., text, graphic, label, and/or icon) of a home (e.g., building, residence, business, and/or structure) including (and/or having) the first room. In some embodiments, the identifier of the home is displayed while (e.g., after and/or in response to) detecting the input. In some embodiments, the identifier of the home is displayed separate from the room list. In some embodiments, the identifier of the home is included with (e.g., and/or includes) the room list. In some embodiments, the home includes all of the rooms in the room list. In some embodiments, the identifier of the home is a name and/or address of the home. In some embodiments, a change to the identifier of the home (e.g., to a different home) includes a change to the room list (e.g., to a room list corresponding to the different home). Displaying an identifier of a home including a room that a device is currently performing an operation in allows the computer system to provide an indication to the user of the home with respect to which inputs and outputs are being provided, thereby providing additional control options without cluttering the user interface with additional displayed controls, and/or providing improved visual feedback to the user.

In some embodiments, while displaying the room list, the computer system displays, via the one or more display generation components, an identifier (e.g., 628c, 664a, and/or 664b) (e.g., text, graphic, label, and/or icon) of a first portion (e.g., including the first room and/or one or more rooms different from the first room) (e.g., section, floor, zone, and/or region) of a home (e.g., building, residence, business, and/or structure). In some embodiments, the identifier of the first portion of the home is displayed while (e.g., after and/or in response to) detecting the input corresponding to the request to modify the room list. In some embodiments, the identifier of the first portion of the home is displayed separate from the room list. In some embodiments, the identifier of the first portion of the home is included with (e.g., and/or includes) the room list. In some embodiments, the identifier of the first portion of the home is a name and/or location of the first portion of the home. Displaying an identifier of a portion of a home allows the computer system to provide to a user information relating to the room list that is displayed and with respect to which inputs and/or outputs are being provided, thereby performing an operation when a set of conditions has been met without requiring further user input, reducing the number of inputs needed to perform an operation, and/or providing improved visual feedback to the user.

In some embodiments, the room list is a first room list (e.g., 630). In some embodiments, the computer system detects, via the one or more input devices, a set of one or more inputs (e.g., 605q and/or 605r) (e.g., a selection input, a non-selection input, a movement input, and/or a non-movement input) corresponding to (e.g., directed to, at a location of, related to, and/or associated with) a request to change (e.g., change, alter, swap, and/or exchange) the first portion of the home to a second portion (e.g., including another room, different from the first room, and/or one or more other rooms different from the first room and/or the other room) (e.g., section, floor, zone, and/or region) of the home, wherein an input of the set of one or more inputs is detected while displaying the identifier of the first portion of the home. In some embodiments, before and/or while detecting an input of the set of one or more inputs corresponding to the request to change the first portion of the home to the second portion of the home, the computer system displays, via the one or more display generation components, a user interface element for selecting a respective portion of the home. In some embodiments, before and/or while detecting an input of the set of one or more input corresponding to the request to change the first portion of the home, the computer system displays, via the one or more display generation components, a user interface element for selecting between the first portion of the home and one or more other portions of the home different from the first portion of the home. In some embodiments, each portion of the home include one or more rooms. In some embodiments, one or more rooms of any one portion of the home are omitted from another (e.g., any other and/or every other) portion of the home. In some embodiments, in response to detecting the set of one or more inputs corresponding to the request to change the first portion of the home to the second portion of the home, the computer system displays, via the one or more display generation components, an identifier (e.g., 628c, 664a, and/or 664b) (e.g., text, graphic, label, and/or icon) of the second portion of the home. In some embodiments, in response to detecting the set of one or more inputs corresponding to the request to change the first portion of the home to the second portion of the home, the computer system displays (e.g., at FIG. 6S), via the one or more display generation components, a third room list (e.g., 630), different from the first room list, corresponding to (e.g., being within) the second portion of the home. In some embodiments, in response to detecting the set of one or more inputs corresponding to the request to change the first portion of the home to the second portion of the home, the computer system ceases and/or forgoes display of the identifier of the first portion of the home and/or the first room list. In some embodiments, the first room list corresponds to the first portion of the home. In some embodiments, a change to the identifier of the first portion of the home (e.g., to a different home and/or to a different portion of the home) include a change from the first room list to the third room list. In some embodiments, the third room list includes a selectable user interface element for removing a room from the third room list (e.g., and/or adding a room to the third room list). In some embodiments, the third room list includes or is displayed with a list of one or more additional rooms (e.g., a fourth room list) corresponding to the second portion and for which the device has not performed, is not performing, and/or is not to perform one or more operations. In response to detecting a set of one or more inputs corresponding to a request to change a first portion of a home to a second portion of a home, displaying an identifier of the second portion of the home and a room list corresponding to the second portion of the home allows the computer system to provide to a user information relating to the portion of the home and the room list with respect to which the user can provide inputs, thereby performing an operation when a set of conditions has been met without requiring further user input, reducing the number of inputs needed to perform an operation, providing additional control options without cluttering the user interface with additional displayed controls, and/or providing improved visual feedback to the user.

Note that details of the processes described above with respect to process 700 (e.g., FIG. 7) are also applicable in an analogous manner to other processes described herein. For example, process 900 optionally includes one or more of the characteristics of the various processes described above with reference to process 700. For example, the device of method 900 can be the device of method 700. For brevity, these details are not repeated herein.

FIGS. 8A-8J illustrate exemplary user interfaces for managing operations of a controlled device using a smart watch in accordance with some embodiments. The user interfaces in these figures are used to illustrate the processes described below, including the processes in FIG. 9.

FIGS. 8A-8J illustrate computer system 800 as a smart watch. It should be recognized that computer system 800 can be other types of computer systems, such as a smart phone, a tablet, a laptop, a desktop, a communal device, an accessory, a laptop computer, a fitness tracking device, and/or a head-mounted display (HMD) device. As illustrated in FIG. 8A, computer system 800 includes rotatable mechanism 878. In some embodiments, in response to detecting an input directed to rotatable mechanism 878, computer system 800 performs an operation to show different parts of a user interface.

FIGS. 8A-8J illustrate a process for interacting with the controlled device. Interacting with the controlled device can allow computer system 800 to display data regarding the use of the controlled device and/or provide controls that allow the user to view, interact with and/or manage the controlled device. In some embodiments, the controlled device is a mobile controlled device, such as a robot, a vacuum, and/or a mop.

As illustrated in FIG. 8A, computer system 800 displays user interface 802 (e.g., a controlled device user interface). User interface 802 includes play/pause control 802a, status indicator 802b, location indicator 802c, mode indicator 802d, rooms region 802e, selected rooms indicator 802e1, and alert control 802f. It should be recognized that more, fewer, and/or different elements can be included in user interface 802. As illustrated in FIG. 8A, each of play/pause control 802a and rooms region 802e is displayed as a selectable user interface element.

In some embodiments, in response to detecting an input directed to play/pause control 802a, computer system 800 sends a signal to the controlled device to activate and/or deactivate. For example, in response to detecting an input to play/pause control 802a while the controlled device is inactive (e.g., the symbol of play/pause control 802a is play), computer system 800 sends a signal to the controlled device to tell it to activate (e.g., play and/or start). As another example, in response to detecting an input to play/pause control 802a while the controlled device is active (e.g., the symbol of play/pause control is pause), computer system 800 sends a signal to the controlled device to tell it to deactivate (e.g., pause and/or stop). In some embodiments, when the controlled device is paused, after a certain amount of time, the controlled device can return to the base station. As illustrated in FIG. 8A, computer system 800 displays play/pause control 802a with the appearance of a triangle (e.g., a play symbol).

In some embodiments, computer system 800 displays status indicator 802b to indicate the status of the controlled device (e.g., whether the controlled device is active, inactive, and/or what operation it is performing). As illustrated in FIG. 8A, status indicator 802b is displayed as “Idle”, indicating that the controlled device is inactive (e.g., is not performing an operation). In some embodiments, computer system 800 displays location indicator 802c to indicate the current location of the controlled device. As illustrated in FIG. 8A, location indicator 802c is displayed as “Base station”, indicating that the controlled device is located at the base station.

In some embodiments, computer system 800 displays mode indicator 802d to indicate the mode (e.g., type of operation) that the controlled device will enter upon activation. As illustrated in FIG. 8A, mode indicator 802d is displayed as “Vacuuming”, indicating that, upon activation, the controlled device can perform a vacuuming operation.

In some embodiments, computer system 800 displays rooms region 802e to include selected rooms for the controlled device to perform an operation in. In some embodiments, computer system 800 displays selected rooms indicator 802e1 to indicate what rooms are selected for the controlled device to perform an operation in. As illustrated in FIG. 8A, selected rooms indicator 802e1 is displayed as “All rooms”, indicating that the controlled device will perform the selected operation (e.g., in this case, vacuuming as indicated by mode indicator 802d) in all rooms in the home. In some embodiments, rooms region 802e includes specific rooms rather than all rooms. For example, in a scenario where only the kitchen is selected for the controlled device to operate in, selected rooms indicator 802ₑ1 is displayed as “Kitchen”, indicating that the controlled device will perform the selected operation only in the kitchen. In some embodiments, in response to detecting an input directed to alert control 802f, computer system 800 sends a signal to the controlled device to output a noise (e.g., by means of a speaker and/or speaker system belonging to the controlled device) to alert the user to the location of the controlled device. It should be recognized that, in some embodiments, alert control 802f is only displayed when the controlled device is away from the base station. In other embodiments, alert control 802f is always displayed, regardless of whether the controlled device is away from the base station. At FIG. 8A, computer system 800 detects selection input 805a directed to rooms region 802e. In some embodiments, selection input 805a is a tap input on rooms region 802e.

As illustrated in FIG. 8B, in response to detecting selection input 805a, computer system 800 ceases display of user interface 802 and displays user interface 804 (e.g.,

User interface 804 includes exit control 804a, done control 804b, rooms region 804c, portion control 804d, caret 804d1, caret 804d2, and selected rooms list 804e. In some embodiments, in response to detecting an input directed to exit control 804a, computer system 800 ceases display of user interface 804 and displays user interface 802. As illustrated in FIG. 8B, each of exit control 804a, done control 804b, rooms region 804c, portion control 804d, caret 804d1, caret 804d2, and selected rooms list 804e is displayed as a selectable user interface element. In some embodiments, in response to detecting an input directed to done control 804b, computer system 800 ceases display of user interface 804 and displays user interface 802. It should be recognized that more, fewer, and/or different elements can be included in user interface 804.

In some embodiments, computer system 800 displays rooms region 804c to indicate the chosen rooms in the home that the controlled device will perform an operation in. Rooms region 804c includes all rooms indicator 804c1, specific rooms indicator 804c2, and selection indicator 804c3. In some embodiments, in response to detecting an input directed to all rooms indicator 804c1, computer system 800 selects all rooms for the controlled device to perform an operation on upon activation. In some embodiments, in response to detecting an input directed to specific rooms indicator 804c2, computer system 800 selects specific rooms for the controlled device to perform an operation on upon activation. In some embodiments, selection indicator 804c3 indicates the rooms chosen for the controlled device to perform an operation in. As illustrated in FIG. 8B, selection indicator 804c3 is displayed next to all rooms indicator 804c1, indicating that the controlled device will perform an operation in all rooms in the home. As illustrated in FIG. 8B, each of all rooms indicator 804cl and specific rooms indicator 804c2 is displayed as a selectable user interface element.

In some embodiments, in response to detecting an input directed to portion control 804d, computer system 800 displays a user interface element that can allow the user to choose which rooms are displayed as options in user interface 804 depending on the portion (e.g., level, segment and/or floor of the home) chosen. As illustrated in FIG. 8B, portion control 804d is displayed as “Main floor” to indicate that the rooms displayed within user interface 804 correspond to the main floor of the home. In some embodiments, in response to detecting an input directed to caret 804d1, computer system 800 changes the portion for which computer system 800 displays rooms for. Additionally, in some embodiments, in response to detecting an input directed to caret 804d 1, portion control 804d is displayed as whatever name the selected portion is set to. For example, in response to detecting an input directed to caret 804d1, computer system 800 displays portion control 804d as “Upstairs” to reflect the change of the selected portion. In some embodiments, in response to detecting an input directed to caret 804d2, computer system 800 changes the portion for which computer system 800 displays rooms for. Additionally, in some embodiments, in response to detecting an input directed to caret 804d2, portion control 804d is displayed as whatever name the selected portion is set to.

In some embodiments, computer system 800 displays selected rooms list 804e to indicate which rooms in the home the controlled device will perform an operation in with the selection of either all rooms indicator 804cl or specific rooms indicator 804c2. As illustrated in FIG. 8B, selected rooms list 804e includes minus control 806, room indicator 808 (e.g., “Kitchen”), minus control 810, room indicator 812 (e.g., “Dining room”), minus control 814, room indicator 816 (e.g., “Hallway”), minus control 818, room indicator 820 (e.g., “Guest Bathroom”), minus control 822, room indicator 824 (e.g., “Guest Bedroom”), minus control 826, and room indicator 828 (e.g., “Office”) (e.g., because all rooms indicator 804cl is selected and portion control 804d is displayed as “Main floor”, all rooms corresponding to the main floor of the home are selected for the controlled device to perform an operation in upon activation). As illustrated in FIG. 8B, each of minus control 806, minus control 810, minus control 814, minus control 818, minus control 822, and minus control 826 is displayed as a selectable user interface element.

In some embodiments, in response to detecting an input directed to minus control 806, computer system 800 ceases display of room indicator 808 within selected rooms list 804e. In some embodiments, in response to detecting an input directed to minus control 810, computer system 800 ceases display of room indicator 812 within selected rooms list 804e. In some embodiments, in response to detecting an input directed to minus control 814, computer system 800 ceases display of room indicator 816 within selected rooms list 804e. In some embodiments, in response to detecting an input directed to minus control 818, computer system 800 ceases display of room indicator 820 within selected rooms list 804e. In some embodiments, in response to detecting an input directed to minus control 822, computer system 800 ceases display of room indicator 824 within selected rooms list 804e. In some embodiments, in response to detecting an input directed to minus control 826, computer system 800 ceases display of room indicator 828 within selected rooms list 804e. In some embodiments, computer system 800 displays a removed room indicator within a new user interface element. In some embodiments, the order of room indicators 808, 812, 816, 820, 824, and/or are different. In some embodiments, different room indicators are included within selected rooms list 804e. At FIG. 8B, computer system 800 detects selection input 805b directed to specific rooms indicator 804c2. In some embodiments, selection input 805b is a tap input.

At FIG. 8C, in response to detecting selection input 805b1, computer system 800 selects specific rooms for the controlled device to perform an operation on upon activation. Additionally, as illustrated in FIG. 8C, selection indicator 804c3 is displayed next to specific rooms indicator 804c2, indicating that the controlled device will perform an operation within specific rooms in the home. As illustrated in FIG. 8C, computer system 800 displays minus control 806, room indicator 808 (e.g., “Kitchen”), minus control 810, room indicator 812 (e.g., “Dining room”), minus control 814, and room indicator 816 (e.g., “Hallway”) within selected rooms list 804e (e.g., computer system 800 selects the kitchen, the dining room, and the hallway as rooms for the controlled device to perform an operation in upon activation). Additionally, in response to detecting selection input 805b, more rooms list 804f is displayed to include other rooms that can be added to selected rooms list 804e (e.g., more rooms list 804f includes rooms that are not selected for the controlled device to perform an operation in upon activation).

More rooms list 804f includes plus control 832, room indicator 820 (e.g., “Guest Bathroom”), plus control 834, room indicator 824 (e.g., “Guest Bedroom”), plus control 836, and room indicator 828 (e.g., “Office”). As illustrated in FIG. 8C, each of plus control 832, plus control 834, and plus control 836 is displayed as a selectable user interface element.

In some embodiments, in response to detecting an input directed to plus control 832, computer system 800 ceases display of room indicator 820 within more rooms list 804f and displays room indicator 820 within selected rooms list 804e (e.g., computer system 800 adds the room back to the selected rooms for the controlled device to perform an operation on upon activation). In some embodiments, in response to detecting an input directed to plus control 834, computer system 800 ceases display of room indicator 824 within more rooms list 804f and displays room indicator 824 within selected rooms list 804e. In some embodiments, in response to detecting an input directed to plus control 836, computer system 800 ceases display of room indicator 828 within more rooms list 804f and displays room indicator 828 within selected rooms list 804e. In some embodiments, in response to detecting an input directed to rotatable mechanism 878, computer system 800 scrolls down user interface 804 to display additional rooms included in more rooms list 804f. At FIG. 8C, computer system 800 detects selection input 805c directed to plus control 836. In some embodiments, selection input 805c is a tap input on plus control 836.

As illustrated in FIG. 8D, in response to detecting selection input 805c, computer system 800 ceases display of room indicator 828 (e.g., “Hallway”) within more rooms list 804f and displays room indicator 828 within selected rooms list 804e (e.g., computer system 800 adds the Hallway to the list of rooms for the controlled device to perform an operation on). At FIG. 8D, computer system 800 detects selection input 805d directed to done control 804b. In some embodiments, selection input 805d is a tap input on done control 804b.

As illustrated in FIG. 8E, in response to detecting selection input 805d, computer system 800 ceases display of user interface 804 and displays user interface 802. As illustrated in FIG. 8E, in response to selecting specific rooms within user interface 804 (e.g., selection input 805b and selection input 805c), computer system 800 displays selected rooms indicator 802e1 as “Kitchen, dining rooms, hallway, office” to indicate that, upon activation, the controlled device can perform an operation in the selected rooms. At FIG. 8E, computer system 800 detects input 805e directed to mode indicator 802d. In some embodiments, input 805e is a swipe input in a first direction along an axis. In some embodiments, input 805e is a tap input (e.g., on mode indicator 802d). In some embodiments, input 805e is a voice command. In some embodiments, input 805e is a swipe input that is detected based on its direction rather than its location. For example, such a swipe input can be over certain selectable user interface elements without being detected as a selection thereof.

As illustrated in FIG. 8F, in response to detecting input 805e, computer system 800 ceases display of user interface 802 and displays user interface 830 (e.g., a mode selection user interface). User interface 830 includes mode indicator 830a, mop indicator 830b, vacuum indicator 830c, vacuum and mop indicator 830d and selection indicator 830e. As illustrated in FIG. 8F, each of mop indicator 830b, vacuum indicator 830c, and vacuum and mop indicator 830d is displayed as a selectable user interface element. It should be recognized that more, fewer, and/or different elements can be included in user interface 830.

In some embodiments, computer system 800 displays mode indicator 830a to indicate the mode (e.g., type of operation) that the controlled device will enter upon activation. In some embodiments, in response to detecting an input directed to mop indicator 830b, computer system 800 designates mopping as the operation the controlled device will perform upon activation. In some embodiments, in response to detecting an input directed to vacuum indicator 830c, computer system 800 designates vacuuming as the operation the controlled device will perform upon activation. In some embodiments, in response to detecting an input directed to vacuum-and-mop indicator 830d, computer system 800 designates mopping and vacuuming as the operation the controlled device will perform upon activation. In some embodiments, computer system 800 displays selection indicator 830e to indicate which mode is selected (e.g., which operation the controlled device will perform upon activation). As illustrated in FIG. 8J, selection indicator 830e is displayed over vacuum indicator 830c, indicating that the controlled device will perform a vacuuming operation upon activation. At FIG. 8F, computer system 800 detects downward swipe input 805f directed to vacuum indicator 830c. In some embodiments, downward swipe input 805f is a rotation input directed to rotatable mechanism 878. In some embodiments, downward swipe input 805f is a tap input. In some embodiments, downward swipe input 805f is a voice command. In some embodiments, another input (e.g., swipe input with different direction and/or rotation input with different direction) can select a different indicator, such as mop indicator 830d.

As illustrated in FIG. 8G, in response to detecting downward swipe input 805f, computer system 800 scrolls mode indicator 830a, mop indicator 830b, vacuum indicator 830c, and vacuum and mop indicator 830d down. As a part of scrolling the display down, computer system 800 displays selection indicator 830e over mop indicator 830b, indicating that the controlled device will perform a mopping operation upon activation. At FIG. 8G, computer system 800 detects input 805g directed to mop indicator 830b. In some embodiments, input 805e is a swipe input in a second direction along an axis (e.g., the same axis as input 805e and/or in an opposite direction with respect to input 805e). In some embodiments, input 805e is a swipe input that is detected based on its direction rather than its location. For example, such a swipe input can be over certain selectable user interface elements without being detected as a selection thereof.

As illustrated in FIG. 8H, in response to detecting swipe input 805g, computer system 800 ceases display of user interface 830 and displays user interface 802. As illustrated in FIG. 8G, in response to changing the mode (e.g., in response to detecting downward swipe input 805f), mode indicator 802d is displayed as “Mop” to indicate that the controlled device will perform a mopping operation upon activation. At FIG. 8H, computer system 800 detects selection input 805h directed to play/pause control 802a. In some embodiments, selection input 805h is a tap input.

As illustrated in FIG. 8I, in response to detecting selection input 805h directed to play/pause control 802a, computer system 800 sends a signal to the controlled device to activate. At FIG. 8I, in response to receiving a signal from computer system 800, the controlled device activates and begins performing the selected operation (e.g., “Mopping”). As illustrated in FIG. 8I, in response to detecting selection input 805h, mode indicator 802d is displayed as “Mopping” to indicate that the controlled device is performing an operation (e.g., mopping). In some embodiments Additionally, location indicator 802c is displayed as “Kitchen” to indicate that the controlled device is mopping in the kitchen. As illustrated in FIG. 8I, computer system 800 displays play/pause control 802a with the appearance of two vertical rectangles (e.g., a pause symbol). In some embodiments, play/pause control 802a is displayed with a different visual element to indicate that the controlled device is performing a different operation. In some embodiments, in response to detecting an input directed to play/pause control 802a while play/pause control is displayed as pause, computer system 800 sends a signal to the controlled device to pause (e.g., stop and/or deactivate). In some embodiments, the controlled device remains in one place while paused. In some embodiments, the controlled device returns to the base station if paused for more than a certain amount of time.

Additionally, as illustrated in FIG. 8I, play/pause control 802a is displayed with small water drops appearing to come from the bottom of the control to indicate that the controlled device is performing a mopping operation.

FIG. 8J illustrates a separate embodiment. At FIG. 8J, the controlled device makes a determination that the water tank is empty. In response to making a determination that the water tank is empty, the controlled device sends a signal of the status to computer system 800. As illustrated in FIG. 8J, in response to receiving a signal of the status of the controlled device, computer system 800 updates user interface 802 to include device error indicator 802g and error type indicator 802h to reflect the status of the controlled device.

In some embodiments, computer system 800 displays device error indicator 802g to indicate an error. As illustrated in FIG. 8J, device error indicator 802g is displayed as “Water Tank Empty”, indicating that the water tank of the controlled device and/or the base station is empty. In some embodiments, computer system 800 displays error type indicator 802h to indicate that an error with the controlled device is occurring. As illustrated in FIG. 8I, error type indicator 802h is displayed as a faucet, indicating that the water tank is empty.

Additionally, as part of updating user interface 802 to reflect the status of the controlled device, computer system 800 displays status indicator 802b as “Returning to station” to indicate that the controlled device is returning to the base station. As illustrated in FIG. 8J, computer system 800 displays location indicator 802c as “Kitchen” to indicate that the controlled device is currently in the kitchen and/or the controlled device was performing an operation (e.g., mopping) in the kitchen as it determined that the water tank is empty.

FIG. 9 is a flow diagram illustrating a process (e.g., process 900) for displaying user interfaces to control a device in accordance with some embodiments. Some operations in process 900 are, optionally, combined, the orders of some operations are, optionally, changed, and some operations are, optionally, omitted.

As described below, process 900 provides an intuitive way for displaying user interfaces to control a device. Process 900 reduces the cognitive burden on a user, thereby creating a more efficient human-machine interface. For battery-operated computing devices, enabling a user to interact with such devices faster and more efficiently conserves power and increases the time between battery charges.

In some embodiments, process 900 is performed at a computer system (e.g., 800) that is in communication (e.g., wired communication and/or wireless communication) with one or more display generation components (e.g., a display screen, a projector, a head mounted display, and/or a touch-sensitive display) and one or more input devices (e.g., a camera, a depth sensor, a microphone, a hardware input mechanism, a rotatable input mechanism, a physical input mechanism, a button, a crown, a knob, a dial, a physical slider, an accelerometer, a mouse, a keyboard, a touchpad, and/or a touch-sensitive surface). In some embodiments, the computer system is a watch, a phone, a tablet, a fitness tracking device, a processor, a head-mounted display (HMD) device, a communal device, a media device, a speaker, a television, an electronic device, and/or a personal computing device.

While (e.g., after and/or in response to) displaying, via the one or more display generation components, a first user interface (e.g., 802) (e.g., a home screen, an application screen, and/or a user interface that is displayed while an application is active) including a first selectable user interface element (e.g., 802e1) (e.g., a virtual button, an icon, a widget, a control, and/or a window) for selecting a set of one or more rooms (e.g., zones, regions, areas, and/or spaces) and a second selectable user interface element (e.g., 802a) (e.g., a virtual button, an icon, a widget, a control, and/or a window), different from the first selectable user interface element, for changing a state (e.g., start, pause, and/or stop) of a device (e.g., mobile device, robot device, cleaning device, vacuum device, mopping device, controlled device, remote controlled device, external device, and/or robot vacuum) with respect to performing a first type of operation (e.g., cleans, vacuums, mops, and/or traverses) in the one or more rooms, the computer system detects (902), via the one or more input devices, an input (e.g., 805a, 805e, and/or 805h) (e.g., a selection input, a non-selection input, a movement input, and/or a non-movement input). In some embodiments, the first user interface includes an indication of a status of the device. In some embodiments, the first user interface includes an indication of the first type of operation. In some embodiments, the first user interface includes an identification of one or more rooms for which the device is currently performing and/or is to perform a respective operation. In some embodiments, in response to an input corresponding to (e.g., directed to, at a location of, related to, and/or associated with) the second selectable user interface element, the computer system changes the state of the device with respect to performing the first type of operation in the one or more selected rooms. In some embodiments, a selection input includes a tap input, a verbal input, an audible command, a gaze input, an air gesture input, a mouse click, and/or a submission of a physical hardware element. In some embodiments, a non-selection input includes a verbal input, an audible request, an audible command, an audible statement, a swipe input, a hold-and-drag input, a gaze input, an air gesture input, and/or a mouse movement. In some embodiments, a movement input includes movement of a subject, a swipe gesture input, a flick gesture input, movement of a mount, movement on a touch-sensitive surface, an air gesture moving from one location to another, rotation of a physical input mechanism, and/or rotation of an electronic stylus. In some embodiments, a non-movement input includes a verbal input, an audible request, an audible command, an audible statement, a tap input, a hold-and-drag input, a gaze input, an air gesture input, mouse movement, and/or a mouse click. In some embodiments, detecting the input comprises detecting an input that does not correspond to the first selectable user interface element and/or the second selectable user interface element.

In response to (904) detecting the input, in accordance with a determination that the input is a first type of input (e.g., a movement input, such as a movement input in a left or right direction), the computer system displays (906), via the one or more display generation components, a second user interface (e.g., 830) (e.g., a home screen, an application screen, and/or a user interface that is displayed while an application is active) (e.g., without displaying the first user interface) different from the first user interface, wherein the second user interface includes a third selectable user interface element (e.g., 830b, 830c, and/or 830d) (e.g., a virtual button, an icon, a widget, a control, and/or a window) for changing (e.g., modifying, altering, and/or updating) the first type of operation to another type of operation (e.g., cleans, vacuums, mops, and/or traverses) different from the first type of operation.

In response to (904) detecting the input, in accordance with a determination that the input is a second type of input (e.g., a selection input) different from the first type of input, the computer system forgoes (908) (e.g., at FIGS. 8B and 8I) display of, via the one or more display generation components, the second user interface (e.g., maintains display of the first user interface). In some embodiments, displaying the second user interface includes ceasing display of the first user interface. In some embodiments, displaying the second user interface includes replacing the first user interface with the second user interface. In some embodiments, the second user interface includes an indication of the first type of operation and a second type of operation different from the first type of operation. In some embodiments, the second user interface includes an indication of a selected one of the first type of operation and the second type of operation. In some embodiments, the computer system updates the indication of the selected one of the first type of operation and the second type of operation in response to detecting a set of one or more inputs including an input directed to the third selectable user interface element. In some embodiments, in response to an additional input corresponding to (e.g., directed to, at a location of, related to, and/or associated with) the second selectable user interface element, the computer system changes the state of the device with respect to performing the selected one of the first type of operation and the second type of operation in the one or more selected rooms. In some embodiments, in response to detecting the input and in accordance with a determination that the input corresponds to the first selectable user interface element (and/or that the input is the second type of input), the computer system initiates a process to change the set of one or more rooms. In some embodiments, in response to detecting the input and in accordance with a determination that the input corresponds to the second selectable user interface element (and/or that the input is the second type of input), the computer system initiates a process to change the state of the device with respect to performing the first type of operation in the one or more rooms. In some embodiments, in response to detecting the input and in accordance with a determination that the input corresponds to the second selectable user interface element, the computer system forgoes display of, via the one or more display generation components, the second user interface. In some embodiments, in response to detecting the input and in accordance with a determination that the input corresponds to the second selectable user interface element, the computer system maintains the first user interface. In some embodiments, the first type of input is a swipe input. In some embodiments, the second type of input is a non-swipe input. In some embodiments, the second type of input is (e.g., includes) a tap input. In some embodiments, the second type of input is different from the first type of input. In some embodiments, the computer system displays the second user interface without display of the first user interface. In response to detecting an input while displaying a user interface including (1) a selectable user interface element for selecting a set of one or more rooms and (2) a selectable user interface element for changing a state of a device with respect to performing a first type of operation in the one or more rooms, selectively displaying a user interface including a selectable user interface element for changing the first type of operation to another type of operation allows the computer system to provide a user experience for managing a process of a device, thereby performing an operation when a set of conditions has been met without requiring further user input, reducing the number of inputs needed to perform an operation, providing additional control options without cluttering the user interface with additional displayed controls, and/or providing improved visual feedback to the user.

In some embodiments, while the device is performing the first type of operation, the first user interface includes a fourth selectable user interface element (e.g., 802f) (e.g., a virtual button, an icon, a widget, a control, and/or a window) for instructing the device (e.g., transmitting an instruction to the device and/or causing the device) to provide an output (e.g., sound, light, and/or vibration). In some embodiments, in response to detecting an input (e.g., a selecting input and/or a non-selection input) corresponding to the fourth selectable user interface element, the computer system instructs the device (e.g., transmits an instruction to the device and/or causes the device) to provide the output. In some embodiments, the output is provided by an output device (e.g., speaker, light emitter, actuator) of the device. In some embodiments, the output includes sound, light, and/or vibration. In some embodiments, the first user interface does not include the fourth selectable user interface element while the device is not performing the first type of operation. A user interface including multiple selectable user interface elements for managing a device including a selectable user interface element for instructing the device to provide an output allows the computer system to assist a user in finding the device, thereby performing an operation when a set of conditions has been met without requiring further user input, reducing the number of inputs needed to perform an operation, and/or providing improved feedback to the user.

In some embodiments, in accordance with a determination that the device is in an error state (e.g., a state in which the device is unable to perform the first type of operation and/or another operation), the first user interface includes an indication (e.g., 802g and/or 802h) (e.g., status, text, graphic, icon, and/or animation) of the error state. In some embodiments, in accordance with a determination that the device is not in the error state, the first user interface does not include the indication of the error state (e.g., at FIGS. 8A and/or 8I). In some embodiments, the error state is a state of the device in which the device requires an action performed with respect to the device. In some embodiments, the error state is a state of the device in which the device is unable to perform one or more operations. In some embodiments, the error state is a state of the device in which the device requires intervention in order to perform the first type of operation and/or another type of operation different from the first type of operation. In some embodiments, the indication of the error state includes a description of the error state. In some embodiments, the indication of the error state includes an instruction to the user to perform an action with respect to the device and/or a base station associated with the device. In some embodiments, the indication of the error state is displayed with the first selectable user interface element and/or the second selectable user interface element. A user interface selectively including an indication of an error state allows the computer system to indicate to a user when a state of the device has a problem, thereby performing an operation when a set of conditions has been met without requiring further user input and/or providing improved visual feedback to the user.

In some embodiments, the second selectable user interface element is for instructing the device (e.g., transmitting an instruction to the device and/or causing the device) to start (e.g., commence, initiate, and/or resume) performance of the first type of operation in the one or more rooms while the device is not performing the first type of operation in the one or more rooms (e.g., at FIGS. 8A, 8E, 8H, and/or 8J). In some embodiments, in response to detecting the input and in accordance with a determination that the input corresponds to the second selectable user interface element, the computer system maintains the first user interface (e.g., including the first selectable user interface element and/or the second selectable user interface element). In some embodiments, in response to detecting the input and in accordance with a determination that the input corresponds to the second selectable user interface element, the computer system performs one or more processes described above with respect to process 700. In some embodiments, instructing the device to start performance of the first type of operation in the one or more rooms includes instructing the device to commence, initiate, and/or resume an operation different from a current operation and/or to depart from a base station. In some embodiments, instructing the device to start performance of an operation includes instructing the device to cease performance of a current operation. A user interface including a selectable user interface element for instructing a device to start performance of a first type of operation in one or more rooms allows the computer system to provide a user the ability to manage execution of one or more processes by the device, thereby performing an operation when a set of conditions has been met without requiring further user input, reducing the number of inputs needed to perform an operation, and/or providing improved visual feedback to the user.

In some embodiments, the first user interface includes a first representation (e.g., 802a and/or 802d at FIG. 8A) (e.g., text and/or graphics) of the first type of operation while detecting the input. In some embodiments, in response to detecting the input and in accordance with a determination that a first set of one or more criteria is satisfied, wherein the first set of one or more criteria includes a criterion that is satisfied when the input corresponds to the second selectable user interface element, the computer system displays, via the one or more display generation components, a second representation (e.g., 802a and/or 802d at FIG. 8H) of the first type of operation, wherein the second representation is different from the first representation. In some embodiments, the input corresponds to the second selectable user interface element when the input is a tap input on the second selectable user interface element. In some embodiments, the first set of one or more criteria includes a criterion that is satisfied when the device is not performing the first type of operation. In some embodiments, the first representation is a first type of representation (e.g., text). In some embodiments, the second representation is a second type of representation (e.g., graphic) different from the first type of representation. In some embodiments, in response to detecting the input and in accordance with the determination that the first set of one or more criteria is satisfied, the computer system displays the first representation of the first type of operation along with the second representation of the first type of operation. In some embodiments, in response to detecting the input and in accordance with the determination that the first set of one or more criteria is satisfied, the computer system ceases display of, via the one or more display generation components, the first representation of the first type of operation. In some embodiments, the second selectable user interface element has a first appearance before detecting the input. In some embodiments, the second selectable user interface element with the first appearance includes an indication that selection of the second selectable user interface starts performance of the first type of operation in the one or more rooms (e.g., a play icon). In some embodiments, in response to detecting the input and in accordance with the determination that the first set of one or more criteria is satisfied, the computer system displays, via the one or more display generation components, the second selectable user interface element with a second appearance different from the first appearance. In some embodiments, the second selectable user interface element with the second appearance includes an indication that selection of the second selectable user interface stop and/or pauses performance of the first type of operation in the one or more rooms (e.g., a pause icon). Displaying different representations of a type of operation depending on whether a device is performing the type of operation allows the computer system to visually indicate what the device is doing with different representations, thereby performing an operation when a set of conditions has been met without requiring further user input and/or providing improved visual feedback to the user.

In some embodiments, the second selectable user interface element is for instructing the device (e.g., transmitting an instruction to the device and/or causing the device) to stop (e.g., pause, suspend, cease, forgo, and/or return to a base station) performance of the first type of operation in the one or more rooms while the device is performing the first type of operation in the one or more rooms (e.g., at FIG. 8I). In some embodiments, in response to detecting the input and in accordance with a determination that the input corresponds to the second selectable user interface element, the computer system maintains the first user interface (e.g., including the first selectable user interface element and/or the second selectable user interface element). In some embodiments, in response to detecting the input and in accordance with a determination that the input corresponds to the second selectable user interface element, the computer system performs one or more process described above with respect to process 700. In some embodiments, instructing the device to stop performance of the first type of operation in the one or more rooms includes instructing the device to pause, suspend, cease, and/or forgo a current operation and/or to return to a base station. In some embodiments, instructing the device to stop performing a current operation includes instructing the device to perform another operation different from the current operation. A user interface including a selectable user interface element for instructing a device to stop performance of a first type of operation in one or more rooms allows the computer system to provide a user the ability to manage execution of one or more processes by the device, thereby performing an operation when a set of conditions has been met without requiring further user input, reducing the number of inputs needed to perform an operation, and/or providing improved visual feedback to the user.

In some embodiments, the first user interface includes a second representation (e.g., 802a and/or 802d at FIG. 8H) of the first type of operation while detecting the input. In some embodiments, in response to detecting the input and in accordance with a determination that a second set of one or more criteria (e.g., different from the first set of one or more criteria) is satisfied, wherein the second set of one or more criteria includes a criterion that is satisfied when the input corresponds to the second selectable user interface element, the computer system displays, via the one or more display generation components, a first representation (e.g., 802a and/or 802d at FIG. 8A) of the first type of operation, wherein the first representation is different from the second representation. In some embodiments, he input corresponds to the second selectable user interface element when the input is a tap input on the second selectable user interface element. In some embodiments, the second set of one or more criteria includes a criterion that is satisfied when the device is performing the first type of operation and/or is performing an operation different from the first type of operation. In some embodiments, the first representation is a first type of representation (e.g., text). In some embodiments, the second representation is a second type of representation (e.g., graphic) different from the first type of representation. In some embodiments, in response to detecting the input and in accordance with the determination that the second set of one or more criteria is satisfied, the computer system displays the second representation of the first type of operation along with the first representation of the first type of operation. In some embodiments, in response to detecting the input and in accordance with the determination that the second set of one or more criteria is satisfied, the computer system ceases display of, via the one or more display generation components, the second representation of the first type of operation. Displaying different representations of a type of operation depending on whether a device is performing the type of operation allows the computer system to visually indicate what the device is doing with different representations, thereby performing an operation when a set of conditions has been met without requiring further user input and/or providing improved visual feedback to the user.

In some embodiments, in response to detecting the input and in accordance with a determination that a second set of one or more criteria is satisfied, wherein the second set of one or more criteria includes a criterion that is satisfied when the input corresponds to (e.g., is located at) the second selectable user interface element, the computer system instructs the device to return (e.g., travel to and/or remain at) to a base station (e.g., at FIG. 8I). In some embodiments, instructing the device to return to the base station includes instructing the device to cease performance of a current operation. In some embodiments, in response to detecting the input and in accordance with the determination that the second set of one or more criteria is satisfied, the computer system displays, via the one or more display generation components, an indication that the device is returning to the base station. Instructing a device to return to a base station in response to detecting an input allows the computer system to enable a user to manage operation of the device, thereby performing an operation when a set of conditions has been met without requiring further user input and/or reducing the number of inputs needed to perform an operation.

In some embodiments, in response to detecting the input and in accordance with a determination that a third set of one or more criteria is satisfied (e.g., the second set of one or more criteria or another set of one or more criteria different from the second set of one or more criteria), wherein the third set of one or more criteria includes a criterion that is satisfied when the input corresponds to (e.g., is located at) the second selectable user interface element and a criterion that is satisfied when the device is performing the first type of operation in the one or more rooms, the computer system instructs the device to stop (e.g., pause, suspend, cease, and/or forgo) performance of the first type of operation in the one or more rooms (e.g., at FIG. 8I). In some embodiments, instructing the device to stop performance of the first type of operation in the one or more rooms includes instructing the device to remain idle (e.g., remain in place and/or forgo performing one or more operations). In some embodiments, in response to another input and/or in accordance with a determination that an additional input satisfies another set of one or more criteria, the computer instructs the device to start (e.g., commence, initiate, and/or resume) an operation. In some embodiments, in response to detecting the input and in accordance with the determination that the third set of one or more criteria is satisfied, the computer system displays, via the one or more display generation components, an indication that the device is stopping and/or has stopped performance of the first type of operation in the one or more rooms. Instructing a device to stop performance of a type of operation in response to detecting an input allows the computer system to enable a user to manage operation of the device, thereby performing an operation when a set of conditions has been met without requiring further user input and/or reducing the number of inputs needed to perform an operation.

In some embodiments, in response to detecting the input and in accordance with a determination that the input corresponds to (e.g., is located at) the first selectable user interface element, the computer system displays (e.g., at FIG. 8B), via the one or more display generation components, (1) a fifth selectable user interface element (e.g., 804c1) (e.g., a virtual button, an icon, and/or a control) corresponding to (e.g., directed to, related to, and/or associated with) selection of all rooms of a portion of a home for the device to perform the first type of operation and (2) a sixth selectable user interface element (e.g., 804c2) (e.g., a virtual button, an icon, and/or a control) corresponding to (e.g., directed to, related to, and/or associated with) selection of one or more specific rooms (e.g., fewer than and/or a subset of) of the portion of the home for the device to perform the first type of operation. In some embodiments, in response to detecting the input and in accordance with the determination that the input corresponds to the first selectable user interface element, the computer system ceases display of the first selectable user interface element and/or the second selectable user interface element. In some embodiments, in response to detecting the input and in accordance with the determination that the input corresponds to the first selectable user interface element, the computer system maintains display of the first selectable user interface element and/or the second selectable user interface element. In some embodiments, the selection of one or more specific rooms of the portion of the home is a selection of fewer than all rooms of the portion of the home. Displaying different selectable user interface elements to select all or a portion of a home allows the computer system to enable a user to manage operation of a device, thereby performing an operation when a set of conditions has been met without requiring further user input, reducing the number of inputs needed to perform an operation, and/or providing improved visual feedback to the user.

In some embodiments, the input is a first input. In some embodiments, while (and/or after) displaying the sixth selectable user interface element, the computer system detects, via the one or more input devices, a second input (e.g., 805b) (e.g., a selection input, a non-selection input, a movement input, and/or a non-movement input) different from the first input. In some embodiments, in response to detecting the second input and in accordance with a determination that the second input corresponds to (e.g., is located at) the sixth selectable user interface element, the computer system displays, via the one or more display generation components: a first room list (e.g., 804e) (e.g., list of first rooms, zones, regions, areas, and/or spaces) including a first set of one or more rooms (e.g., corresponding to the portion of the home) for the device to perform the first type of operation; a seventh selectable user interface element (e.g., 806, 810, 814, and/or 818) (e.g., a virtual button, an icon, and/or a control) for removing, from the first room list, at least one room from the first set of one or more rooms; a second room list (e.g., 804f) (e.g., list of second rooms, zones, regions, areas, and/or spaces) including a second set of one or more second rooms (e.g., corresponding to the portion of the home) for the device to forgo performance of the first type of operation; and an eighth selectable user interface element (e.g., 832, 834, and/or 836) (e.g., a virtual button, an icon, and/or a control) for adding, to the first room list, at least one room from the second set of one or more rooms. In some embodiments, in response to detecting the second input and in accordance with the determination that the second input corresponds to the sixth selectable user interface element, the computer system maintains display of the fourth selectable user interface and/or the sixth selectable user interface elements. In some embodiments, in response to detecting the second input and in accordance with the determination that the second input corresponds to the sixth selectable user interface element, the computer system ceases display of the fourth selectable user interface and/or the sixth selectable user interface elements. In some embodiments, removing, from the first room list, at least one room from the first set of one or more rooms includes adding a room of the first set of one or more rooms to the second room list. In some embodiments, adding, to the first room list, at least one room from the second set of one or more rooms includes removing a room of the second set of one or more rooms from the second room list. In some embodiments, the first room list, the seventh selectable user interface element, the second room list, and/or the eighth selectable user interface element are displayed in response to detecting the first input and/or in accordance with the determination that the first input corresponds to the first selectable user interface element. In some embodiments, the computer system adds the room to the first room list simultaneous with removing the room from the second room list. In some embodiments, the computer system removes the room from the first room list simultaneous with adding the room to the second room list. In some embodiments, in response to detecting another input and/or in accordance with another set of one or more criteria, the computer system updates the first room list by changing an order of the rooms in the first room list. Displaying selectable user interface elements to add and remove rooms from a room list allows the computer system to enable a user to manage operation of a device, thereby performing an operation when a set of conditions has been met without requiring further user input, reducing the number of inputs needed to perform an operation, and/or providing improved visual feedback to the user.

In some embodiments, in response to detecting the input and in accordance with a determination that the input corresponds to (e.g., is located at) the first selectable user interface element, displaying, via the one or more display generation components, a first room list (e.g., 804e) (e.g., list of first rooms, zones, regions, areas, and/or spaces) including a first set of one or more rooms (e.g., corresponding to the portion of the home) for the device to perform the first type of operation. In some embodiments, in response to detecting the input and in accordance with a determination that the input corresponds to (e.g., is located at) the first selectable user interface element, displaying, via the one or more display generation components, a seventh selectable user interface element (e.g., 806, 810, 814, 818, 822, and/or 826) (e.g., a virtual button, an icon, and/or a control) for removing, from the first room list, at least one room from the first set of one or more rooms. In some embodiments, in response to detecting the input and in accordance with a determination that the input corresponds to (e.g., is located at) the first selectable user interface element, displaying, via the one or more display generation components, an eighth selectable user interface element (e.g., 832, 834, and/or 836) (e.g., a virtual button, an icon, and/or a control) for adding, to the first room list, at least one room. In some embodiments, in response to detecting the input and in accordance with the determination that the input corresponds to (e.g., is located at) the first selectable user interface element, the computer system displays, via the one or more display generation components and with the first room list, the seventh selectable user interface element, and/or the eighth selectable user interface element, (1) a fifth selectable user interface element (e.g., a virtual button, an icon, a widget, a control, and/or a window) corresponding to (e.g., directed to, related to, and/or associated with) a selection of all rooms of the portion of a home for the device to perform the first type of operation and (2) a sixth selectable user interface element (e.g., a virtual button, an icon, a widget, a control, and/or a window) corresponding to (e.g., directed to, related to, and/or associated with) a selection of specific rooms (e.g., fewer than and/or a subset of) of the portion of the home for the device to perform the first type of operation. In some embodiments, in response to detecting the input and in accordance with the determination that the input corresponds to (e.g., is located at) the first selectable user interface element, the computer system displays, via the one or more display generation components and with the first room list, the seventh selectable user interface element, and/or the eighth selectable user interface element, a second room list (e.g., list of second rooms, zones, regions, areas, and/or spaces) including a second set of one or more rooms (e.g., corresponding to the portion of the home) for the device to forgo performance of the first type of operation. In some embodiments, the input is a first input. In some embodiments, the computer system detects, via the one or more input devices, a second input different from the first input. In some embodiments, in response to detecting the second input and in accordance with a determination that the second input corresponds to the sixth selectable user interface element, the computer system maintains display of the fourth selectable user interface and/or the sixth selectable user interface elements. In some embodiments, in response to detecting the second input and in accordance with a determination that the second input corresponds to the sixth selectable user interface element, the computer system ceases display of the fourth selectable user interface and/or the sixth selectable user interface element. In some embodiments, removing at least one room of the first set of one or more rooms from the first room list includes adding the at least one room of the first set of one or more rooms to the second room list. In some embodiments, adding the at least one room of the second set of one or more rooms to the first room list includes removing the at least one room of the second set of one or more rooms from the second room list. In some embodiments, the first room list, the seventh selectable user interface element, the second room list, and/or the eighth selectable user interface element are displayed in response to the first input and/or in accordance with the determination that the first input corresponds to the first selectable user interface element. In some embodiments, the computer system adds a room to the first room list simultaneous with removing the room from the second room list. In some embodiments, the computer system removes a room from the first room list simultaneous with adding the room to the second room list. In some embodiments, in response to another input and/or in accordance with another set of one or more criteria, the computer system updates the first room list by changing an order of the rooms in the first room list. Displaying a room list with an ability to add and remove rooms from the room list allows the computer system to enable a user to manage operation of a device, thereby performing an operation when a set of conditions has been met without requiring further user input, reducing the number of inputs needed to perform an operation, and/or providing improved visual feedback to the user.

In some embodiments, the input is a first input. In some embodiments, in response to detecting the input and in accordance with a determination that the first input is the input is the first type of input, the second user interface includes an indication that the first type of operation is active. In some embodiments, the first type of input is a swipe input in a first direction. In some embodiments, while (e.g., after and/or in response to) displaying the second user interface, the computer system detects, via the one or more input devices, a third input (e.g., 805f) (e.g., a selection input, a non-selection input, a movement input, and/or a non-movement input), different from the first input, corresponding to a request to change the first type of operation to a second type of operation different from the first type of operation. In some embodiments, detecting the third input includes detecting an input that does not correspond to the first selectable user interface element and/or the second selectable user interface element. In some embodiments, the third input is a vertical swipe input. In some embodiments, in response to detecting the third input, the computer system displays, via the one or more display generation components, an indication (e.g., 830f) that the second type of operation is active (e.g., and not the first type of operation). In some embodiments, in response to detecting another input while displaying the second user interface (e.g., the other input corresponding to a request to change the first type of operation to a third type of operation different from the first type of operation and the second type of operation), the computer system displays, via the one or more display generation components, an indication that the third type of operation is active (e.g., and not the first type of operation or the second type of operation). In some embodiments, the other input is a swipe input in a particular direction opposite the direction of the third input. In some embodiments, while displaying the indication that the second type of operation is active and while displaying the second user interface, the computer system detects, via the one or more input devices, a fourth input (e.g., 805g) (e.g., a selection input, a non-selection input, a movement input, and/or a non-movement input) different from the first input and the third input. In some embodiments, detecting the third input includes detecting an input that does not correspond to the third selectable user interface element. In some embodiments, the computer system detects the third input without having detected a (e.g., any) second input. In some embodiments, in response to detecting the fourth input and in accordance with a determination that the fourth input is a fifth type of input, the computer system displays, via the one or more display generation components, the first user interface including an indication (e.g., 802d at FIG. 8H) of the second type of operation (e.g., without including the indication of the first type of operation). Providing a flow between different user interfaces to change a type of operation being performed allows the computer system to enable a user to manage operation of a device, thereby performing an operation when a set of conditions has been met without requiring further user input, providing additional control options without cluttering the user interface with additional displayed controls, and/or providing improved visual feedback to the user.

In some embodiments, the first user interface includes an indication (e.g., 802d at FIG. 8A) (e.g., text, graphic, label, icon, color, emphasis, highlighting, and/or animation) of the first type of operation while (and/or before) detecting the first input. In some embodiments, before and/or while detecting the first input, the first user interface does not include the indication of the second type of operation. A user interface including an indication of a type of operation before hanging to another type of operation allows the computer system to indicate a current state of a device configured to perform the type of operation, thereby performing an operation when a set of conditions has been met without requiring further user input, reducing the number of inputs needed to perform an operation, and/or providing improved visual feedback to the user.

In some embodiments, the determination that the first input is the first type of input includes a determination that the first input is in a first direction along an axis (e.g., at FIG. 8E). In some embodiments, the determination that the fourth input is the fifth type of input includes a determination that the fourth input is in a second direction opposite from the first direction along the axis (e.g., at FIG. 8G). In some embodiments, the fifth type of input is a swipe input in the second direction different from (e.g., opposite) the first direction of the first type of input. In some embodiments, the fifth type of input and the first type of input are directional inputs. In some embodiments, the second direction of the fifth type of input and the first direction of the first type of input are in opposite directions along a same axis. In some embodiments, the third type of input is a swipe input in a direction that is different from the direction of the first type of input and/or the fifth type of input. In some embodiments, a direction of the third type of input is in an axis that is different from the axis of the first type of input and the fifth type of input. In some embodiments, the third type of input is transverse to and/or orthogonal to the axis of the first type of input and the fifth type of input. In some embodiments, the third type of input is not a directional input (e.g., is a tap input). Traversing between user interfaces using inputs of opposite directions allows the computer system to provide an intuitive flow of user interfaces that maximizes screen space, thereby performing an operation when a set of conditions has been met without requiring further user input, providing additional control options without cluttering the user interface with additional displayed controls, and/or providing improved visual feedback to the user.

Note that details of the processes described above with respect to process 900 (e.g., FIG. 9) are also applicable in an analogous manner to the processes described herein. For example, process 700 optionally includes one or more of the characteristics of the various processes described herein with reference to process 900. For example, the updates to the room list of method 700 can be provided in one or more user interfaces displayed in method 900. For brevity, these details are not repeated herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve management of operations of a controlled device. The present disclosure contemplates that in some instances, this gathered data may include personal information data that uniquely identifies or can be used to contact or locate a specific person. Such personal information data can include demographic data, location-based data, telephone numbers, email addresses, social media identifiers, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used for managing operations of a controlled device. Accordingly, use of such personal information data enables users to have a computer system perform operations for managing operations of a controlled device. Further, other uses for personal information data that benefit the user are also contemplated by the present disclosure. Management data relating to the user's interactions with respect to the controlled device can be used to optimize the operations of the controlled device.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of some services, the present technology can be configured to allow users to select to “opt in” or “opt out” of participation in the collection of personal information data during registration for services or anytime thereafter. In another example, users can select not to provide certain data for some services. In yet another example, users can select to limit the length of time data is maintained or entirely prohibit the development of user profile. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other processes.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the some services, or publicly available information.

What is claimed is:

1. A method, comprising:
at a computer system that is in communication with one or more display generation components and one or more input devices:
while displaying, via the one or more display generation components, a room list including an indication that a device is currently performing a respective operation in a first room, detecting, via the one or more input devices, an input corresponding to a request to modify the room list; and
in response to detecting the input corresponding to the request to modify the room list:
in accordance with a determination that a first set of one or more criteria is satisfied, updating the room list in a first manner; and
in accordance with a determination that a second set of one or more criteria, different from the first set of one or more criteria, is satisfied, updating the room list in a second manner different from the first manner.

2. The method of claim 1, wherein, in accordance with a determination that the device has completed a respective operation in a second room different from the first room, the room list includes an indication that the device has completed the respective operation in the second room.

3. The method of claim 1, wherein, in accordance with a determination that the device has not yet started a respective operation in a third room different from the first room, the room list includes an indication that the device has not yet started the respective operation in the third room.

4. The method of claim 1, wherein:
in accordance with a determination that the respective operation is a first operation, the indication that the device is currently performing the respective operation includes first content; and
in accordance with a determination that the respective operation is a second operation different from the first operation, the indication that the device is currently performing the respective operation includes second content different from the first content.

5. The method of claim 1, wherein the indication that the device is currently performing the respective operation in the first room is a first indication, wherein the respective operation is a first respective operation, the method further comprising:
after the first respective operation is performed and in accordance with a determination that the device is performing a second respective operation separate from the first respective operation, displaying, via the one or more display generation components, a second indication that the device is currently performing the second respective operation, wherein the second indication is separate from the first indication.

6. The method of claim 5, wherein the second indication corresponds to the first room.

7. The method of claim 5, wherein second indication corresponds to a fourth room different from the first room.

8. The method of claim 5, wherein the first indication has a first appearance, and wherein the second indication has the first appearance.

9. The method of claim 1, wherein updating the room list in the first manner includes removing a fifth room from the room list.

10. The method of claim 9, wherein, while detecting the input corresponding to the request to modify the room list, the room list includes an indication that the device has completed an operation in the fifth room.

11. The method of claim 9, wherein, while detecting the input corresponding to the request to modify the room list, the room list includes an indication that the device has not yet performed an operation in the fifth room.

12. The method of claim 9, wherein:
the room list is a first room list; and
updating the first room list in the first manner includes adding the fifth room to a second room list different from the first room list.

13. The method of claim 9, wherein:
while detecting the input corresponding to the request to modify the room list, the room list includes a first selectable user interface element associated with the fifth room; and
the first set of one or more criteria includes a first criterion that is satisfied when the input corresponds to the first selectable user interface element.

14. The method of claim 1, wherein updating the room list in the second manner includes adding a sixth room to the room list, and wherein the sixth room is different from the first room.

15. The method of claim 14, wherein:
the room list is a first room list; and
updating the room list in the second manner includes removing the sixth room from a second room list different from the first room list.

16. The method of claim 1, wherein the room list includes a seventh room and an eighth room different from the seventh room, wherein the room list includes an indication that the device has not yet performed one or more operations in the seventh room, wherein the room list includes an indication that the device has not yet performed one or more operations in the eighth room, the method further comprising:
in response to detecting the input corresponding to the request to modify the room list and in accordance with a determination that a third set of one or more criteria is satisfied, changing an order, in the room list, of the seventh room with respect to the eighth room.

17. The method of claim 1, further comprising:
while displaying the room list, displaying, via the one or more display generation components, an identifier of a home including the first room.

18. The method of claim 1, further comprising:
while displaying the room list, displaying, via the one or more display generation components, an identifier of a first portion of a home.

19. The method of claim 18, wherein the room list is a first room list, the method further comprising:
detecting, via the one or more input devices, a set of one or more inputs corresponding to a request to change the first portion of the home to a second portion of the home, wherein an input of the set of one or more inputs is detected while displaying the identifier of the first portion of the home; and
in response to detecting the set of one or more inputs corresponding to the request to change the first portion of the home to the second portion of the home:
displaying, via the one or more display generation components, an identifier of the second portion of the home; and
displaying, via the one or more display generation components, a third room list, different from the first room list, corresponding to the second portion of the home.

20. A non-transitory computer-readable storage medium storing one or more programs configured to be executed by one or more processors of a computer system that is in communication with one or more display generation components and one or more input devices, the one or more programs including instructions for:
while displaying, via the one or more display generation components, a room list including an indication that a device is currently performing a respective operation in a first room, detecting, via the one or more input devices, an input corresponding to a request to modify the room list; and
in response to detecting the input corresponding to the request to modify the room list:
in accordance with a determination that a first set of one or more criteria is satisfied, updating the room list in a first manner; and
in accordance with a determination that a second set of one or more criteria, different from the first set of one or more criteria, is satisfied, updating the room list in a second manner different from the first manner.

21. A computer system configured to communicate with one or more display generation components and one or more input devices, comprising:
one or more processors; and
memory storing one or more programs configured to be executed by the one or more processors, the one or more programs including instructions for:
while displaying, via the one or more display generation components, a room list including an indication that a device is currently performing a respective operation in a first room, detecting, via the one or more input devices, an input corresponding to a request to modify the room list; and
in response to detecting the input corresponding to the request to modify the room list:
in accordance with a determination that a first set of one or more criteria is satisfied, updating the room list in a first manner; and
in accordance with a determination that a second set of one or more criteria, different from the first set of one or more criteria, is satisfied, updating the room list in a second manner different from the first manner.
